(19) United States
(12) Patent Application Publication
(10) Pub. No.: US 2020/0410346 A1
(43) Pub. Date: Dec. 31, 2020

(54) SYSTEMS AND METHODS FOR USING AND TRAINING A NEURAL NETWORK

(71) Applicant: YISSUM RESEARCH DEVELOPMENT COMPANY OF THE HEBREW UNIVERSITY OF JERUSALEM LTD, Jerusalem (IL)

(72) Inventor: Ari RAPPOPORT, Jerusalem (IL)

(21) Appl. No.: 16/976,174

(22) PCT Filed: Feb. 27, 2019
(86) PCT No.: PCT/IL2019/050222

§ 371 Date: Aug. 27, 2020

Related U.S. Application Data
(60) Provisional application No. 62/635,767, filed on Feb. 27, 2018.

(51) Int. Cl. G06N 3/08; G06N 3/04

(52) U.S. Cl. CPC G06N 3/08; G06N 3/04

(57) ABSTRACT

There is provided a controller for control of a processor based system, comprising: a hardware processor(s) executing a code for: during an inference process of a neural network: feeding into the neural network (NN) input signals from sensors monitoring the processor based system, wherein the feeding triggers propagation of a forward dataflow in a forward direction from input to output and a non-forward dataflow in a non-forward direction from output to input, wherein the non-forward dataflow occurs at least one of before and simultaneously with the forward dataflow, wherein the forward dataflow and the non-forward dataflow establish candidate communication channels each mapping the input signals to candidate outputs, wherein a single communication channel is selected from the candidate communication channels, and outputting a single response mapped to the input signals by the single communication channel, the single response denoting instructions for control of the processor based system.

### RELATED APPLICATION

This application claims the benefit of priority of U.S. Provisional Patent Application No. 62/635,767 filed on Feb. 27, 2018, the contents of which are incorporated herein by reference in their entirety.

### BACKGROUND

The present invention, in some embodiments thereof, relates to neural networks and, more specifically, but not exclusively, to systems and methods for training and using neural networks.

Artificial neural networks map an input to an output. Some artificial neural networks act as classifiers, by assigning a classification value to the input. For example, for an input image, the neural network may output names of people in the image. Artificial neural networks are based on a large number of neurons (inspired by brain neurons) that have input and output connections. Some neurons inputs receive the input, and some (usually most) receive inputs from other neurons. Some neuron outputs target other neurons, while some neurons provide the main output result.

### SUMMARY

According to a first aspect, a controller for control of a processor based system, comprises: at least one hardware processor executing a code for: during an inference process of a neural network: feeding into the neural network (NN) a plurality of input signals from a plurality of sensors monitoring the processor based system, wherein the feeding triggers propagation of a forward dataflow in a forward direction from input to output and a non-forward dataflow in a non-forward direction from output to input, wherein the non-forward dataflow occurs at least one of before and simultaneously with the forward dataflow, wherein the forward dataflow and the non-forward dataflow establish a plurality of candidate communication channels each mapping the input signals to a plurality of candidate outputs, wherein a single communication channel is selected from the plurality of candidate communication channels, and outputting a single response mapped to the input signals by the single communication channel, the single response denoting instructions for control of the processor based system.

According to a second aspect, a controller for control of a processor based system, comprises: at least one hardware processor executing a code for: during an inference process of a neural network: feeding into a neural network (NN) a plurality of input signals from a plurality of sensors monitoring the processor based system, wherein the NN comprises a plurality of candidate channel neurons arranged into clusters, and a plurality of inter-cluster neurons that connect between the clusters, wherein the feeding triggers propagation between clusters of a forward dataflow in a forward direction from input to output and a non-forward dataflow in a non-forward direction from output to input, wherein the non-forward dataflow occurs at least one of before and simultaneously with the forward dataflow, wherein the forward dataflow and the non-forward dataflow establish a plurality of candidate communication channels via clusters, each mapping the input signals to a plurality of candidate outputs, wherein a single communication channel is selected from the plurality of candidate communication channels by a competition process implemented by the inter-cluster neurons that exclude a sub-set of the clusters of the plurality of candidate communication channels and select another sub-set of the clusters of the plurality of candidate communication channels, and outputting a single response mapped to the input signals by the single communication channel, the single response denoting instructions for control of the processor based system.

According to a third aspect, a method for data processing, comprises: during an inference process of a neural network: feeding into a neural network (NN) a plurality of input signals, wherein the feeding triggers propagation of a forward dataflow in a forward direction from input to output and a non-forward dataflow in a non-forward direction from output to input, wherein the forward dataflow and the non-forward dataflow establish a plurality of candidate communication channels each mapping the input signals to a plurality of candidate outputs, wherein the non-forward dataflow occurs at least one of before and simultaneously with the forward dataflow, wherein a single communication channel is selected from the plurality of candidate communication channels, and outputting a single response mapped to the input signals by the single communication channel.

According to a fourth aspect, a controller for control of a processor based system, comprises: at least one hardware processor executing a code for: during an inference process of a neural network: feeding into a neural network (NN) a plurality of input signals from a plurality of sensors monitoring the processor based system, wherein the NN comprises a plurality of neurons, and a plurality of inter-cluster neurons that connect between the neurons, wherein a competition process implemented by inter-cluster neurons excludes a sub-set of the neurons and selects another sub-set of the neurons, and outputting a single response mapped to the input signals by the selected another sub-set of neurons, the single response denoting instructions for control of the processor based system.

In a further implementation of the first, second, third, and fourth aspects, the NN comprises a plurality of candidate channel cluster neurons that establish the plurality of candidate communication channels, the candidate channel neurons are arranged into clusters, and inter-cluster neurons that connect between the clusters, wherein the forward and non-forward dataflow are between clusters of candidate channel neurons, wherein the single communication channel is selected by a competition process implemented by the inter-cluster neurons that exclude a sub-set of the clusters included in the plurality of candidate communication channels and select another sub-set of clusters included in the plurality of candidate communication channels.

In a further implementation of the first, second, third, and fourth aspects, pairs of candidate channel neurons are connected by focused connections, and candidate channel neurons are stacked and arranged as respective sub-networks in clusters, when the clusters are conceptually organized in a 2D space, a certain cluster connects to at least one other non-neighboring cluster, propagation of flow between clusters is omnidirectional within the 2D space, a single cluster occupies a single location within the 2D space with candidate channel neurons of the single cluster conceptually stacked in at least one other dimension corresponding to the single location of the 2D space.

In a further implementation of the first, second, third, and fourth aspects, inter-cluster neurons reset an aggregated value for each connected candidate channel neuron, wherein a respective candidate channel neurons outputs dataflow when an associated aggregated value exceeds a threshold, wherein the sub-set of the clusters are excluded by inter-cluster neurons resetting aggregated values of the candidate channel neurons of the sub-set to prevent the aggregated values from exceeding the threshold and preventing output of dataflow, wherein another sub-set of clusters is selected when a plurality of aggregated values are reset simultaneously for a plurality of connected candidate channel neurons such that the plurality of aggregated values simultaneously exceed the threshold such that the plurality of connected candidate channel neurons simultaneously output dataflow.

In a further implementation of the first, second, third, and fourth aspects, the plurality of candidate communication channels are established when hard-wired responses that directly establish a single communication channel mapping a defined set of input signals to a defined single response are not triggered by the input signals, wherein the hard-wired responses are at least one of: pre-set NN parameters, and created by training of the NN based on the defined set of input signals and the defined single response.

In a further implementation of the first, second, third, and fourth aspects, respective pairs of candidate channel neurons are bidirectionally connected by the forward dataflow flow and non-forward dataflow between the respective pair of candidate channel neurons, wherein at least some bidirectional connections between respective pairs of candidate channel neurons are unbalanced, wherein forward dataflow is significantly larger than non-forward dataflow, wherein the non-forward dataflow synchronizes activation of the respective pair of candidate channel neurons, wherein the forward dataflow recruits additional candidate channel neurons to the candidate communication channels.

In a further implementation of the first, second, third, and fourth aspects, each cluster includes a plurality of intra-cluster connections between candidate channel neurons of the respective cluster and a plurality of inter-cluster connections between candidate channel neurons of at least one other cluster.

In a further implementation of the first, second, third, and fourth aspects, each cluster includes candidate channel neurons selected from at least one of the following content network types of defined architectures: an input network having an architecture designed for the input signals, an alert network having an architecture designed for identifying input signals that do not trigger a hard wired response or a previously learned automated response for triggering an acute response, a decision making (DM) network having an architecture designed for executing the acute response by computing the plurality of candidate communication channels and triggering selection of the single communication channel, a focus network having an architecture designed for representing actions that are prepared or predicted to be executed in the near future, and a response network having an architecture designed for generating the single response output.

In a further implementation of the first, second, third, and fourth aspects, the input signals are received by the input network, the alert network, and the response network, wherein the input network triggers dataflow into the alert network and the response network, wherein the alert network triggers dataflow into the DM network and candidate channel neurons belonging to the input network in clusters, wherein the DM network triggers dataflow into the focus network, wherein the focus network triggers dataflow into the response network, wherein a main dataflow is from input network to alert network to DM network to focus network to response network.

In a further implementation of the first, second, third, and fourth aspects, clusters of the input network are primary input clusters of the following types: external-input clusters having an architecture designed for receiving entity-external inputs including data from computing devices external to the system and/or outputs of environmental sensors that sense an environment external to the system, internal-input clusters having an architecture designed for receiving entity-internal inputs including data from computing devices internal to the system and/or outputs of system-internal sensors that sense internal parameters of the system, and movement-input clusters having an architecture designed for receiving input from computing devices that control and/or sensors that sense a control mechanism of the system.

In a further implementation of the first, second, third, and fourth aspects, candidate channel neurons of different clusters and of a same network content type triggers dataflow into each other.

In a further implementation of the first, second, third, and fourth aspects, the alert network triggers one or more of (i) instructions for receiving additional inputs from additional devices monitoring the system (ii) output for controlling system-internal controls, and (iii) dataflow into the DM network for triggering an acute response.

In a further implementation of the first, second, third, and fourth aspects, the DM network has an architecture designed for triggering an urgent response based on a process for selecting the single communication channel from the plurality of candidate communication channels and a non-urgent response based on additional recruitment of candidate communication channels into the plurality of candidate communication channels before the single communication channel is selected, by including a sub-set of inter-cluster neurons that suppress certain dataflow and do not suppress other dataflow, each of the urgent response and non-urgent response is triggered by differential responses to the forward and non-forward dataflow.

In a further implementation of the first, second, third, and fourth aspects, inter-cluster neurons are arranged into a plurality of coordination network types comprising: an execution coordination network (ECN) that targets the focus network the response network the input network and the alert network the ECN including inter-cluster neurons that target each other very strongly and strongly target neurons, a competition coordination network (CNN) including (i) suppressive inter-cluster neurons that target the input connections of response network focus network and DM network neurons (ii) disinhibition inter-cluster neurons that target suppression inter-cluster neurons (iii) blanket inter-cluster neurons that target neurons in all networks, and a response suppression network (RSN).

In a further implementation of the first, second, third, and fourth aspects, further comprising detecting an error based on a burst of high frequency sequence of candidate channel neuron signals generated when a non-triggered certain candidate channel neuron is triggered, wherein burst trigger of the certain candidate channel neuron generates higher dataflow when a previous state of the certain candidate channel neuron is non-triggered than when the previous state is partially or fully triggered, wherein during an error situation the bursts are indicative of unpredicted system inputs generating disproportionally strong dataflow which includes creation of the single communication channel that addresses the unpredicted system input.

In a further implementation of the first, second, third, and fourth aspects, the single communication channel triggers creation of at least one candidate predictive communication channel for implementing a next action after the single communication channel is selected, wherein additional input signals selects the next action by selecting a predictive communication channel from another plurality of candidate communication channels including the at least one candidate predictive communication channel.

In a further implementation of the first, second, third, and fourth aspects, a plurality of clusters are arranged as an executive area, wherein the forward dataflow is from primary input clusters to the executive area, and the non-forward dataflow is from the executive area to other clusters, and further comprising another dataflow between different primary input clusters.

In a further implementation of the first, second, third, and fourth aspects, at least some clusters represent a certain external entity by being activated when input indicative of the certain external entity is received by the NN, and not activated when input indicate of other external entities is received by the NN.

In a further implementation of the first, second, third, and fourth aspects, further comprising at least one type-1-auxiliary-cluster comprising neurons, having an architecture designed for providing clusters with input dataflow and to sustain activation of the candidate channel neurons of the clusters and inter-cluster neurons connecting the clusters.

In a further implementation of the first, second, third, and fourth aspects, the type-1-auxiliary-cluster includes a core portion and a matrix portion, wherein neurons of the core portion have an architecture designed for connecting to an input network, to a response network, and to an alert network in a spatially focused manner, and the neurons of the matrix portion having an architecture designed for connecting to a DM network, to an alert network, to a focus network, to a response network, and to a competition coordination network in a more extended diffuse manner.

In a further implementation of the first, second, third, and fourth aspects, the core portion includes a specific sub-portion and a non-specific sub-portion, wherein the specific sub-portion includes neurons having an architecture designed for receiving system input dataflow of a defined type and conveying the input dataflow to primary input clusters, wherein the non-specific sub-portion has an architecture designed for conveying the input dataflow to other clusters.

In a further implementation of the first, second, third, and fourth aspects, the type-1-auxiliary-cluster having an architecture designed for activation by the response network and by a deeper part of the input network.

In a further implementation of the first, second, third, and fourth aspects, further comprising at least one type-2-auxiliary-cluster of neurons, having an architecture designed for controlling access of the clusters to the type-1-auxiliary-cluster.

In a further implementation of the first, second, third, and fourth aspects, the type-2-auxiliary-cluster includes inhibitory input neurons and inhibitory output neurons, wherein the inhibitory output neurons have an architecture designed to provide continuous suppression of the type-1-auxiliary-cluster, and the inhibitory input neurons having an architecture designed to target the inhibitory output neurons.

In a further implementation of the first, second, third, and fourth aspects, to obtain access to the type-1-auxiliary-clusters by clusters of candidate channel neurons, the clusters of candidate channel neurons trigger the inhibitory input neurons of the type-2-auxiliary-cluster using a focus network and the response network for disinhibiting the neurons of the type-1-auxiliary-cluster, for creating a cluster to type-2-auxiliary-cluster to type-1-auxiliary-cluster to cluster connection channel that sustains activation of candidate channel neurons of the clusters.

In a further implementation of the first, second, third, and fourth aspects, further comprising at least one type-3-auxiliary-cluster of neurons that includes an AUX3a subset of neurons that are non-inherently active inhibitory and connect to an AUX3b subset of neurons that are inherently active inhibitory for suppressing responses.

In a further implementation of the first, second, third, and fourth aspects, neurons that trigger AUX3a neurons inhibit AUX3b neurons and disinhibit responses.

In a further implementation of the first, second, third, and fourth aspects, further comprising at least one type-4-auxiliary-cluster of neurons that that includes an AUX4a subset of neurons that are inherently active inhibitory which continuously suppress output neurons of the type-4-auxiliary-cluster that drive responses, wherein when neurons suppress the AUX4a neurons the type-4-auxiliary-cluster outputs are disinhibited for execution.

In a further implementation of the first, second, third, and fourth aspects, at least some neurons modulate the received input signals.

In a further implementation of the first, second, third, and fourth aspects, propagation of at least one of forward dataflow and non-forward dataflow is modulated by neurons arranged in a plurality of connection type (CT) clusters, each CT cluster has an architecture and connectivity for modulating a target set of candidate channel neurons of at least one certain type of content network.

In a further implementation of the first, second, third, and fourth aspects, CT dataflow outputted by CT clusters has a diffuse effect on the target set of candidate channel neurons such that modulation of the target set of candidate channel neurons occurs a function of space of the NN, wherein a relatively strongest modulation effect is trigged by the dataflow from the CT clusters at a centralized location of the target set of candidate channel neurons of the respective type of content network, and a diminishing modulation effect is triggered for increasing distance away from the centralized location.

In a further implementation of the first, second, third, and fourth aspects, dataflow outputted by respective CT clusters for modulation is triggered by a combination of at least one of: candidate channel neurons of the clusters of the NN, neurons of the CT cluster, neurons of other CT clusters, and neurons of at least one auxiliary cluster type.

In a further implementation of the first, second, third, and fourth aspects, a modulation effect obtained in response to dataflow of the CT clusters is according to a respective affinity parameter associated with respective connections of the target set of candidate channel neurons, the affinity parameter affect the modulation for triggering a corresponding output dataflow by respective the candidate channel neuron according to an amount of dataflow from the respective CT cluster.

In a further implementation of the first, second, third, and fourth aspects, relatively high affinity markings are triggered in response to relatively low dataflow from the respective CT cluster for providing a relatively low threshold for triggering the corresponding dataflow in the respective candidate channel neuron, and relatively low affinity markings are triggered in response to relatively high dataflow from the respective CT cluster for providing a relative high threshold for triggering the corresponding dataflow in the respective candidate channel neuron.

In a further implementation of the first, second, third, and fourth aspects, further comprising executing a learning process triggered by the formation of the single communication channel, the learning process triggering changes in the NN for increasing likelihood of future inclusion of the single communication channel in a future plurality of candidate communication channels created in response to a future input signal corresponding to the input signal, and reducing likelihood of non-selected communication channels being included in the future plurality of candidate communication channels.

In a further implementation of the first, second, third, and fourth aspects, the changes in the NN are determined by frequency of dataflow over connections of candidate channel neurons of the clusters included in the single communication channel, and determined according to the dataflow CTs included in the single communication channel.

In a further implementation of the first, second, third, and fourth aspects, the changes occurring to NN are selected from the group consisting of: modifying dataflow capacity of existing neuron connections, creating additional neurons and connections thereof, removing existing neurons and connections thereof, modifying energy utilization, and modifying system protection parameters.

In a further implementation of the first, second, third, and fourth aspects, further comprising executing an acute learning response comprising high frequency dataflow over the single communication channel, activation of certain CT indications facilitating certain dataflow CT of the single communication channel, and activation of the certain CT indications of non-selected communication channels of the plurality of candidate communication channels, wherein the acute learning response increases likelihood of neurons of the single communication channel being included in a future selected single communication channel.

In a further implementation of the first, second, third, and fourth aspects, further comprising triggering a grow process by high frequency dataflow of a certain CT, the grow process at least one of: increases capacity of connections between neurons of the single communication channel, increases branching and extent of the connections, creates new neurons and connections thereof, and increases energy consumption.

In a further implementation of the first, second, third, and fourth aspects, further comprising triggering a shrink process by low frequency dataflow of a certain CT, the shrink process at least one of: decreases capacity of connections of neurons excluded from the single communication channel, decreases branching and extent thereof, removes superfluous connections and neurons, and decreases energy consumption.

In a further implementation of the first, second, third, and fourth aspects, the forward dataflow and non-forward dataflow propagated by outputs of activated clusters trigger low affinity CT indications in vicinity of the respective output site and trigger high affinity CT indications farther away from the respective output site, wherein high frequency dataflow triggers a growth process for increasing likelihood of future inclusion of respective clusters in a future selected single communication channel, and wherein low frequency dataflow triggers a shrink process for decreasing likelihood of future inclusion of respective clusters in the future selected single communication channel, wherein the site of dataflow output near neurons of the single communication channel undergo the growth process and farther neurons undergo the shrink process.

In a further implementation of the first, second, third, and fourth aspects, the input and a target response are provided for training the NN to learn the single communication channel generated from the flow in a forward direction triggered by the input and flow in a non-forward direction triggered by the target response, wherein the flow in the non-forward direction is performed before the flow in the forward direction or simultaneously with the flow in the forward direction.

In a further implementation of the first, second, third, and fourth aspects, the processor based system is selected from the group consisting of electro-mechanical system, computational component without mechanical component, system with at least one sensor, autonomous vehicle, semi-autonomous vehicle, autonomous robot, 2D printer, 3D printer, and combinations of the aforementioned, and the single response is selected from the group consisting of: instructions for navigating the autonomous vehicle, instructions for navigating the semi-autonomous vehicle, instructions for manipulating the autonomous robot, instructions for 2D printing by the 2D printer, instructions for 3D printing by the 3D printer, and combinations of the aforementioned.

In a further implementation of the first, second, third, and fourth aspects, the controller is implemented as at least one of: a plug-in for the processor based system, and integral to the processor based system.

In a further implementation of the fourth aspect, competition excludes the sub-set of neurons and selects another sub-set of the neurons according to a signal-to-noise threshold.

In a further implementation of the fourth aspects, the competition excludes the sub-set of neurons by suppression thereof, and selects another sub-set of the neurons by synchronization thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for executing an inference process using a NN and/or for training the NN, where the NN selects a single communication channel from candidate communication channels established by forward and non-forward dataflows, in accordance with some embodiments of the present invention;

FIG. 2 is a flowchart of a method for executing an inference process using a NN, where the NN selects a single communication channel from candidate communication channels established by forward and non-forward dataflows, in accordance with some embodiments of the present invention;

FIG. 3 is a flowchart of a method for training a NN for, where the NN selects a single communication channel from candidate communication channels established by forward and non-forward dataflows, in accordance with some embodiments of the present invention;

FIG. 4 is a schematic depicting intra-cluster connections between content and coordination networks, in accordance with some embodiments of the present invention;

FIG. 5 is a schematic depicting an architecture of the NN, in accordance with some embodiments of the present invention;

FIG. 6 is a schematic depicting two candidate channel clusters of the NN, in accordance with some embodiments of the present invention;

FIG. 7 is a schematic depicting an exemplary architecture of a type-4-auxiliary cluster, in accordance with some embodiments of the present invention;

FIG. 8 is a schematic depicting two CT clusters of different types, in accordance with some embodiments of the present invention;

FIG. 9 is a dataflow diagram depicting exemplary dataflow for triggering modes, in accordance with some embodiments of the present invention;

FIG. 10 is a schematic depicting the competition process for selecting a single communication channel from multiple candidate communication channels, in accordance with some embodiments of the present invention;

FIG. 11 which is a schematic of a NN in which a single communication channel is selected from multiple communication channels, in accordance with some embodiments of the present invention; and

FIG. 12 which is a flowchart of a method for executing an inference process using an adaptive NN that includes a standard NN and inter-cluster neurons that connect between neurons of the standard NN, in accordance with some embodiments of the present invention.

### DETAILED DESCRIPTION

The present invention, in some embodiments thereof, relates to neural networks and, more specifically, but not exclusively, to systems and methods for training and using neural networks.

An aspect of some embodiments of the present invention relates to systems, an apparatus, methods, and/or code instructions (i.e. stored on a memory and executable by hardware processor(s)) for outputting a single response mapped to input signals by a neural network (NN) architecture that selects a single communication channel from multiple candidate communication. Input signals from sensors monitoring a processor based system are fed into the NN. The feeding triggers propagation of a forward dataflow in a forward direction from input to output, and a non-forward dataflow in a non-forward direction from output to input. The non-forward dataflow occurs before and/or simultaneously with the forward dataflow. It is noted that the non-forward dataflow occurs during the inference process of the NN, and/or occurs before the output is generated by the forward dataflow (in combination with the non-forward dataflow), which is in contrast to standard neural networks that perform non-forward propagation, during the training stage, once the forward flow has completely propagated to the final layer to produce an output. The generated output is then non-forward propagated. The forward dataflow and the non-forward dataflow establish multiple candidate communication channels, each mapping the input signals to multiple candidate outputs. The multiple candidate communication channels may exist simultaneously. A single communication channel is selected from the candidate communication channels. A single response mapped to the input signals is outputted by the single communication channel. The single response denotes instructions for control of the processor based system.

The non-forward dataflow may refer to one or more of: reverse dataflow, intra-layer (i.e., within the same layer) dataflow, unconventional dataflow, vertical dataflow, and dataflow directions other that forward from input to output.

The NN includes multiple candidate channel cluster neurons that establish the candidate communication channels. The candidate channel neurons are arranged into clusters. Each candidate channel cluster may conceptually correspond to a neuron in a standard neural network. The cluster as a whole may be either triggered or non-triggered to further propagate dataflow to other connected clusters, conceptually similar to a single neuron in a standard neural network. However, the cluster architecture enables more complex decision making to determine whether the cluster as a whole is activated or not over standard neural networks. Inter-cluster neurons (which may be organized into clusters) connect between the candidate channel clusters. The forward and non-forward dataflow are between clusters of candidate channel neurons. The single communication channel is selected by a competition process implemented by the inter-cluster neurons that exclude a sub-set of the clusters included in the candidate communication channels and select another sub-set of the clusters included in the candidate communication channels.

It is noted that inter-cluster neurons may be located within clusters of candidate channel neurons.

Optionally, the inter-cluster neurons reset an aggregated value for each connected candidate channel neuron (i.e., the aggregated value is not decreased by a defined amount, such as acting as a negative weight, but reset, optionally to zero). The aggregated value is computed based on weights and dataflows arriving at the neuron from multiple connecting neurons. When the aggregated value is above a threshold, the neuron is triggered to output dataflow, participating in forward and/or non-forward dataflow. The sub-set of the clusters are excluded by inter-cluster neurons resetting aggregated values of the candidate channel neurons of the sub-set to prevent the aggregated values from exceeding the threshold and preventing output of dataflow (i.e., effectively silencing or inhibiting the neurons). The other sub-set of clusters is selected when aggregated values are reset simultaneously for multiple connected candidate channel neurons such that the aggregated values simultaneously exceed the threshold such that the plurality of connected candidate channel neurons simultaneously output dataflow. Effectively, the neurons are synchronized.

Optionally, the NN includes hard-wired responses and/or sufficiently pre-trained responses, where input generates forward and non-forward dataflow that result in a single communication channel without the intermediate process of creating multiple candidate communication channels from which the single communication channel is selected. Such hard-wired responses and/or sufficiently pre-trained responses may represent deterministic connections between candidate channel neurons, which are set-up quickly because the NN has been pre-preprogrammed and/or has been sufficiently trained to handle such inputs. When hard-wired responses and/or sufficiently pre-trained responses are not triggered, the multiple candidate communication channels are established, and resolved by the competition process to arrive at the single communication channel. Such process may conceptually represents a decision making ability by the NN to handle new unforeseen situations. The NN establishes several candidate responses and selects the best one, rather than attempting to identify the single response initially. The decision making process may improve the ability of the NN to make accurate decisions in handling the input.

Optionally, learning of the NN is triggered when input dataflow and output dataflow are fed to the NN. The learning Alternatively or additionally, the learning of the NN is triggered when the input signals do not trigger hard-wired responses and/or sufficiently pre-trained responses, and when the single communication channel is established. The learning process triggers changes in the NN for increasing likelihood of future inclusion of the selected single communication channel in a future set of candidate communication channels created in response to a future input signal corresponding to the input signal, and reducing likelihood of non-selected communication channels being included in the future set of candidate communication channels.

Optionally, the forward and/or non-forward dataflow is modulated by connection type (CT) neurons of different types, arranged in CT clusters. For example, the CT neurons may increase the effect of the forward and/or non-forward dataflow on the target neurons, and/or decrease the effect of the forward and/or non-forward dataflow on the target neurons. The CT clusters connect to the candidate channel neurons of the candidate channel clusters. CT dataflow outputted by the CT clusters has a diffuse effect on the target set of candidate channel neurons. Modulations occurs as a function over a space (space may be defined in different ways) of the NN. For example, relatively stronger modulation effect occurs near a center location, with the modulation effect decreasing with increasing distance away from the center location.

Different CT types may affect the same and/or different target candidate channel neurons. The modulation effect may be determined by affinity parameter(s), that determine how the incoming dataflow is modulated. For example, high value dataflow may be modulated by one affinity parameter to trigger low dataflow. In another example, low value dataflow may be modulated by another affinity parameter to trigger high dataflow.

Optionally, auxiliary clusters of neurons (e.g., similar to the candidate cluster neurons and/or the inter-cluster neurons) are located externally to the candidate channel clusters and to the inter-cluster neurons. The auxiliary clusters provide a feedback loop to stabilize the generated responses, for example, to sustain the dataflow to allow sufficient time for setting up the candidate communication channels and selection of the single communication channel, and/or for sustaining the single communication channel for sufficient time to allow implementation of the outputs by the processor based system. For example, in some cases, without the auxiliary clusters, the dataflows may be short lived, not enabling sufficient time for setting up the candidate communication channels and selection of the single communication channel.

An aspect of some embodiments of the present invention relates to systems, an apparatus, methods, and/or code instructions (i.e. stored on a memory and executable by hardware processor(s)) for training and/or using a neural network as a controller for control of a processor based system. The neural network may be implemented as a standard neural network that include inter-cluster neurons that connect between the neurons (which are optionally arranged in layers), sometimes referred to herein as an adapted neural network. During an inference process of the adapted neural network, input is fed therein. The input may include signals from sensors monitoring the processor based system. A competition process implemented by the inter-cluster neurons excludes a sub-set of the neurons and selects another sub-set of the neurons. A single response is outputted. The output is a mapped to the input signals by the selected another sub-set of neurons. The output may denote instructions for control of the processor based system.

At least some of the systems, methods, apparatus, and/or code instructions described herein address the technical problems of: (i) mapping a set of multiple inputs (e.g., from multiple sensors monitoring a processor based system) to multiple outputs (e.g., components that control different aspects of the processor based system), and (ii) improve ability and/or accuracy of handling inputs for which the NN has not been trained. The problem is especially challenging when the processor based system is an electro-mechanical based system with moving parts, where the output includes instructions for movement of the moving part, for example, automated driving of an automated vehicle.

At least some of the systems, methods, apparatus, and/or code instructions described herein improve the technical field of training neural networks, and/or using neural networks, by using trained neural networks to generate instructions for physical manipulation of a physical system, for example, a robot and/or autonomous vehicle, for example, driving of the autonomous vehicle, and autonomous movement of arms of the robot. The improvement is based on the architecture of the NN described herein, that may be designed and/or trained to output control instructions for physical manipulation of the physical system. The control instructions may be for adjustment of multiple components, for example, for driving an automated vehicle by controlling multiple components of the vehicle based on sensor input. In contrast, traditional neural network architectures are designed to output a classification value for a given input, for example, output a label indicating whether a dog appears in an input image. Traditional neural network are not used to directly generate instructions for physical manipulation of the physical system. An additional controller is required to receive the classification result computed by the standard neural network. The controller computes instructions for physical manipulation of the system based on the classification result.

It is noted that the improvement to the neural network may also be for processor based systems that do not have electro mechanical components and/or moving parts, for example, software based systems, and graphical user interfaces. Control and/or decision making by such software based systems may be improved. At least some of the systems, methods, apparatus, and/or code instructions described herein improve the technical field of training neural networks, and/or using neural networks, by using trained neural networks to map input(s) to output(s), for example, to compute a classification result. The NN described herein provide increased classification accuracy, and/or increased classification ability (e.g., outputting multiple outputs in response to the input(s) in comparison to traditional neural network architectures.

The solution to the technical problems (i) and (ii) are provided by the architecture of the NN. The candidate communication channels may be established when dataflow has not been hardwired and/or has not been previously fully learned (i.e., to establish a virtual hardwiring) also referred to herein as adaptive responses. The candidate communication channels represent candidate outputs in response to the same input signals, for example, possible courses of action an automated vehicle may take in response to receiving an image of an oncoming vehicle indicating risk of collision. For example, the vehicle may swerve to the left, swerve to the right, or brake. The hardwired responses represent pre-programmed responses that cannot be altered, and which do not require resolution. Hard-wired responses are, for example, candidate channel neuron connections that are triggered by pre-determined input types (e.g., single inputs, combinations of multiple inputs). The previously learned responses represent responses for which the NN has been previously trained (e.g., multiple times, or trained precisely once) and for which the output has been sufficiently mapped to the input, for example, a single channel is automatically setup between input and output based on the training rather than multiple channels. As such, the candidate communication channels conceptually represent a decision point between different possible outcomes. The non-forward dataflow is in contrast to standard neural networks, where non-forward flow does not occur during the inference phase. In such standard neural networks, back propagation only occurs during the training phase, and such back propagation only occurs after the input has been forward propagated to the output layer of the neural network. The back propagation does not occur before the forward flow and/or simultaneously with the forward dataflow.

When a hard-wired response is executed, some of the hard-wired neurons implementing the hard-wired response trigger adaptive neurons (in some implementations, the NN location in which this occurs is AUX3 cluster(s)). Such as scenario triggers the adaptive NN to learn the situations in which specific hard-wired responses are triggered. This is useful in two exemplary ways. First, it lets the adaptive NN take into account hard-wired responses during planning (e.g., the DM mode, as described herein). This way, hard-wired responses guide the NN towards the valence (value) of specific situations. For example, if some predefined NN input triggers a ‘consume’ hard-wired response (e.g., as described herein), adaptive responses whose goal is consume automatically seek this type of input. Second, it lets the hard-wired NN be extended by associating inputs that are not hard-wired to any response with a specific hard-wired response. Executed responses usually channel flow in a narrow, focused manner, preventing it from reaching candidate channel neurons that may yield other responses. However, if the NN's inputs persist arriving after the execution of a response, such channeling may not be effective. In this case, persistent inputs may trigger a higher level response (i.e., automated or acute after hard-wired, or acute after automated).

Improvement to training of the NN is provided, for example, by implementations that allow the NN to learn by self discovery the correct output, i.e., learning what from what NN executes. In another implementation, the NN learns by a human manually operating the processor based system. For example, when the processor based system includes an electro-mechanical component with moving parts, the moving parts may be placed in a position indicative of the target output. The position may be set by a human operator and/or automatic code that guides the moving parts. For example, the human operator may manually maneuver the robot arm into a static position indicating the target output, or the maneuver itself provides a dynamic type of target output. In another example, the human operator drives the automatic vehicle, thereby providing target outputs in the form of desired navigation maneuvers in response to target input such as an image of an oncoming vehicle or pedestrian. In another example, when the processor based system is without moving parts, the human may manually use the computer (e.g., application, GUI, code) to provide the target output, for example, performing load-balancing and/or packet re-routing on communication networks. It is noted that the process of providing target output by a human manually operating the moving part component and/or manually using a computer has no counterpart in standard NN training.

Additional improvement to the training of the NN is provided, for example, by the process of adjusting the architecture of the NN during training (i.e., architectural changes). As described herein, the training may trigger a growth process in which additional neurons and/or connections are created, and/or a shrink process in which existing neurons are removed and/or existing connections are pruned. The growth and shrink processes may be performed together (e.g., simultaneously), for example, growth in a centralized region, and shrink in a region a distance away from the centralized region. The growth and/or shrink processes increase likelihood of the region having the growth processes being triggered in response to input similar to the provided training input, and/or decrease likelihood of the region having the shrink process being triggered in response to input similar to the provided training input. The growth and/or shrink processes may direct how the channels are established in response to the input, for example, along the central regions which are focused by inhibiting triggering further away from the central regions. The architectural changes improve the ability of the NN to more accurately and/or more efficiently response to input signals. The architectural changes to the NN are different than a standard training process for training a standard NN, in which only values of predefined weights are adjusted.

The improvements are at least a result of the novel architecture of the NN described herein in comparison to traditional neural networks. First, in traditional neural networks, neurons are arranged in so-called layers, where neurons of a certain layer receive input from neurons of a previous layer, and output to neurons of the next layer. Such layers may be conceptualized as flat, and/or 2D architectures. Layers between the input and output layers are termed hidden layers. Neural networks with more than a single hidden layer are sometimes termed deep neural networks. In contrast, the neurons of the NN described herein are arranged in clusters. Each candidate channel cluster may conceptually correspond to a neuron in a standard neural network. The cluster as a whole may be either triggered or non-triggered to further propagate dataflow to other connected clusters, conceptually similar to a single neuron in a standard neural network. However, the cluster architecture enables more complex decision making to determine whether the cluster as a whole is activated or not over standard neural networks. Second, standard neural networks are all part of the same type of network. In contrast, the NN described herein has inter-neuron connections that are organized into different types of sub-networks (e.g., content networks and coordination networks). The sub-networks help direct the dataflow, to occur from one network to another network in a defined direction, and control the forward and/or non-forward dataflows. Third, standard neural networks have a single stage. The simulation of the NN described herein utilizes a process (termed R(response) process) that has multiple different stages (R modes, or modes). Fourth, the NN uses a novel type of connection (CT connection) based on CT dataflow outputted by CT clusters, which diffusely affects marked neuron connections in order to promote specific modes. Fifth, simulation of the NN utilizes a competition process, predictions, bursts, and/or transitions, to support the selection of responses, response sequences, and hierarchical response sequences, in ways not done by standard neural networks. The single communication channel is selected from the multiple candidate communication channels (set up by the forward and non-forward dataflow) via the competition process. Future responses may be anticipated and partially setup for being triggered by expected input signals predicted to arrive. Sixth, the NN allows neurons to directly modulate system inputs. Neurons may suppress NN inputs when the NN engages in planning, to avoid distraction. Seventh, the NN may use auxiliary neuron clusters to assist the simulation in selecting and sustaining responses, compared to the single neuron module used by other standard neural networks.

Traditional neural networks are trained by a process termed back propagation. Given a training dataset of inputs and corresponding outputs, the input is fed into the neural network, propagated along the layers of neurons, and produces an output. The output of the neural network is compared with a known correct output (also termed ground truth) to yield a numerical representation of the error. The error is propagated along the neural network in the opposite direction (i.e., output to input), and connection weights are updated to minimize the error. Network neural training involves a sequence of such iterative bottom-up (input to output) and top down (output to input) passes. In contrast, the NN described herein is trained differently, by propagating flow from the output to the input in parallel to and/or before propagation from input to output. Moreover, the training of the NN may inherently modify the topology of the NN (e.g., the number of neurons, and their connections). In contrast, training of standard neural networks simply results in an adjustment of the weights of the neurons, without affect the topology of the neural network.

Moreover, the NN described herein is able to handle new situations for which it has not been trained. For situations in which it has been trained, the NN includes hard-wired responses and/or sufficiently pre-trained responses, where input generates forward and non-forward dataflow that result in a single communication channel without the intermediate process of creating multiple candidate communication channels from which the single communication channel is selected. Such hard-wired responses and/or sufficiently pre-trained responses may represent deterministic connections between candidate channel neurons, which are set-up quickly because the NN has been pre-preprogrammed and/or has been sufficiently trained to handle such inputs. When hard-wired responses and/or sufficiently pre-trained responses are not triggered, the multiple candidate communication channels are established, and resolved by the competition process to arrive at the single communication channel. Such process may conceptually represent a decision making ability by the NN to handle new situations for which the NN has not been trained. The NN establishes several candidate responses and selects the best one, rather than attempting to identify the single response initially. The decision making process may improve the ability of the NN to make accurate decisions in handling the input when the NN has not been trained on the specific set of input and output.

The learning process for training the NN described herein is different than the process of training traditional NNs. At least some implementations of the NN described herein are based on adaptive learning. In such a system, the NN itself is adapted, for example, capacities of connections are modified after the NN generates outputs. The goal of this process is to improve the NN's future performance by increasing (or decreasing) the capacity of connections that have contributed to good (or to poor) responses. Different concrete policies (algorithms) for how to change capacities may be used, many defining ‘good’ and ‘poor’ by utilizing external measures indicating the quality of the NN's outputs, for example, based on reinforcement learning.

At least some of the systems, methods, apparatus, and/or code instructions described herein improve the technical field of controlling automated or semi-automated electro-mechanical based systems, which include moving parts, for example, automated vehicles, robots, and robotic arms. The improvement is in the ability of the automated system to learn to operate in a manner similar to how a human manually operates the system, for example, to drive a car in a manner similar to how a human drives a car. The improvement is provided, at least by the architecture of the NN that enables decisions when input to output mappings are not hard-wired and/or not sufficiently learned (e.g., the NN has not been fully trained on the specific scenario). The NN is able to react to new scenarios that arise during operation of the system, learn the best response, and improve generation of the response in the future.

At least some of the systems, methods, apparatus, and/or code instructions described herein improve the technical field of controlling software based systems, which do not include moving parts, for example, internal control of computers, dynamic adaptation of communication networks, and GUIs. The improvement is in the ability of the automated system to learn control multiple components in response to multiple inputs, for example, to decide how to re-route network packets given an existing state of a communication network, and/or to decide how to allocate code within a distributed system. The improvement is provided, at least by the architecture of the NN that enables decisions when input to output mappings are not hard-wired and/or not sufficiently learned (e.g., the NN has not been fully trained on the specific scenario). The NN is able to react to new scenarios that arise during operation of the system, learn the best response, and improve generation of the response in the future.

An example of an improved operation of controlling an automated vehicle using the NN described herein is now provided. The NN receives sensory inputs from various sensors, including video cameras, infra-red sensors, touch sensors, proximity sensors, geographical location sensors, vehicle state sensors (e.g., speed, braking state, wheel orientation), and the like. Sensors may sense physical phenomena, and/or may sense virtual and/or digital phenomena, for example, the sensor may be code that senses processor utilization, amount of remaining memory, and amount of used data storage. The NN has various hard-wired responses (e.g., which may be pre-programmed input to output mappings). The hard-wired responses are designed for mimicking the reflexes of a human driver. Exemplary hard-wired responses include: when something moves quickly from the right into the path of the vehicle, steer the vehicle to the left (e.g., quick motion is detected by a rapid change of many adjacent video pixels). When the vehicle has touched anything, try to move in the opposite direction so that the vehicle does not touch it anymore. When the vehicle is quite close to the target destination, move forward in its direction. Some responses to identified road signs may be hard-wired (e.g., stop at a stop sign). Hard-wired responses serve two exemplary roles. First, they are activated during system test (actual performance) when their input signals are provided. Second, they are used during NN training to guide the NN towards the desired learned responses. During training, the NN may be placed in a real-like, virtual (or real) scenario (e.g., in a road system populated with other vehicles and pedestrians). The NN of the vehicle is given a target destination. The NN of the vehicle is also provided with a sensory input signals that endows it with motivation to reach the destination (e.g., the simplest such input is a continuous input that triggers a hard-wired response to move forward. A more sophisticated input generates higher frequency inputs if the vehicle's energy is decreased, making it more urgent to reach the destination). During training, the default NN responses are to move forward while obeying road signs. In an example, another vehicle in front has slowed down. Sensory input signals (e.g., video pixels, IR) change. The inputs single trigger the input network. In the initial stages of training, the NN has no non-forward dataflow until the vehicle gets quite close to the other vehicle. When this happens, the hard-wired non-forward dataflow responses trigger the NN to generate instructions to stop the vehicle. For example, implemented via AUX3 cluster(s). When the vehicle moves too fast and crashes into the other vehicle, hard-wired responses are triggered to move backward to get away from the other vehicle. During the collision event, there was forward dataflow in the alert network, non-forward dataflow in the DM and focus network, competition, and response network activation in sensory areas. Due to the forward and non-forward dataflow, the NN has learned the association between sensory input signals and responses. Specifically, the NN has learned that in some types of sensory input signals, the NN should slow down (as an average between its inherent “forward” drive and the “backward” response generated due to the collision). The next time input signals convey another vehicle in front that is slowing down, the “slow down” signals are activated by the sensory input signals that the NN had learned to associate with a slowing down vehicle (e.g., this occurs in the DM network). Further competition between triggered candidate channel clusters determines the exact rate of slowing down, until a single focused response (i.e., the single communication channel selected from the multiple candidate communication channels) emerges in the response network to implement slowing down. Gradually, such training sharpens the NN's learned representations (of both sensory objects and responses). It is noted that learning by trial and error is one way to train the NN. Another way, which may be used instead of the trial and error, and/or in conjunction with the trial and error, is for a user to manually drive the vehicle as the NN learns based on the behavior of the driver. The input signals are as described above. The NN is further fed a target training output by the driver manually driving the vehicle. The NN learns to associate the input signals with the target training output.

At least some implementations of the systems, methods, apparatus, and/or code instructions described herein improve a standard neural network (e.g., deep neural network, convolutional neural network, recurrent neural network, other architectures and/or combinations thereof). The improvement is provided by creation of the adapted neural network, by insertion (e.g., via a plug-in) of inter-cluster neurons for connection between the neurons of the standard neural network. The inter-cluster neurons trigger a competition process that selects a sub-set of neurons for generating output, and may exclude (implicitly or explicitly) another sub-set of neurons that do not participate in generating the output. The selection and/or exclusion may be according to a signal-to-noise threshold (e.g., predefined and/or learned during training). The included neurons may be synchronized (e.g., temporarily), and/or the excluded neurons may be suppressed. Standard NN do not implement such competition mechanisms. There is no suppression of some neurons in standard NN, and the “winners are selected simply by being the leading neurons, numerically, and not via a threshold and not by being synched as is done in the adapted NN. The adapted NN may be based on a discrete/binary scheme (i.e., select neuron or exclude neuron), while standard NN are based on a continuous scheme (i.e., different weights of neurons). The adapted NN may provide an extra level of control. The adapted NN may be to significantly more stable to spurious inputs in comparison to standard NN. I.e., once the competition process has selected some neurons for generating output and excluded others, the output (e.g., action plan) that the included neurons implement is relatively more resistant to noise, and/or on-going computation to new inputs is much more efficient in comparison to standard NN, for example, because the computations do not need to take into account the neurons that were already suppressed.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

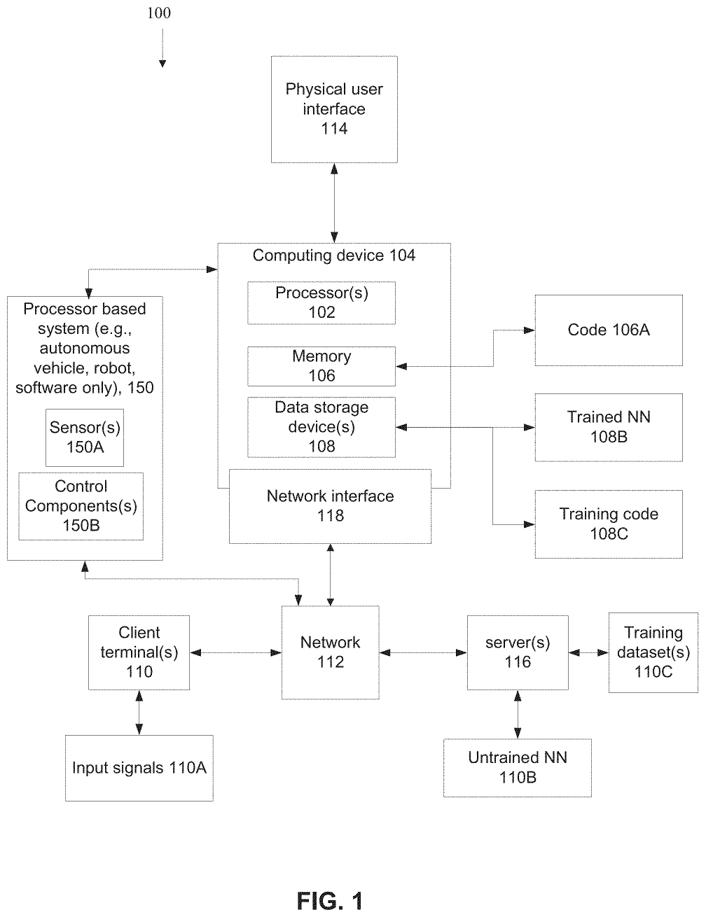

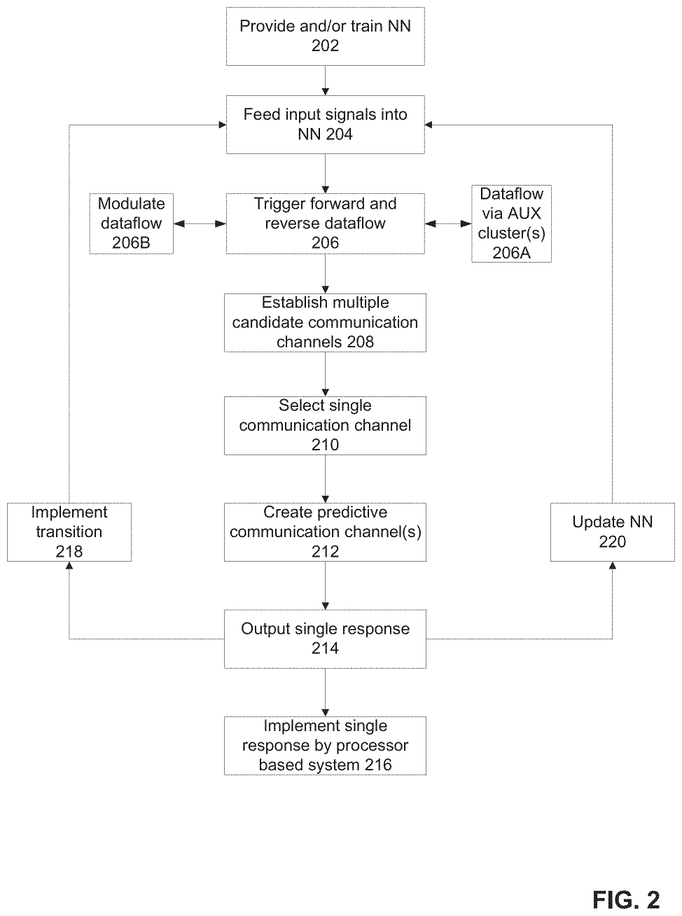

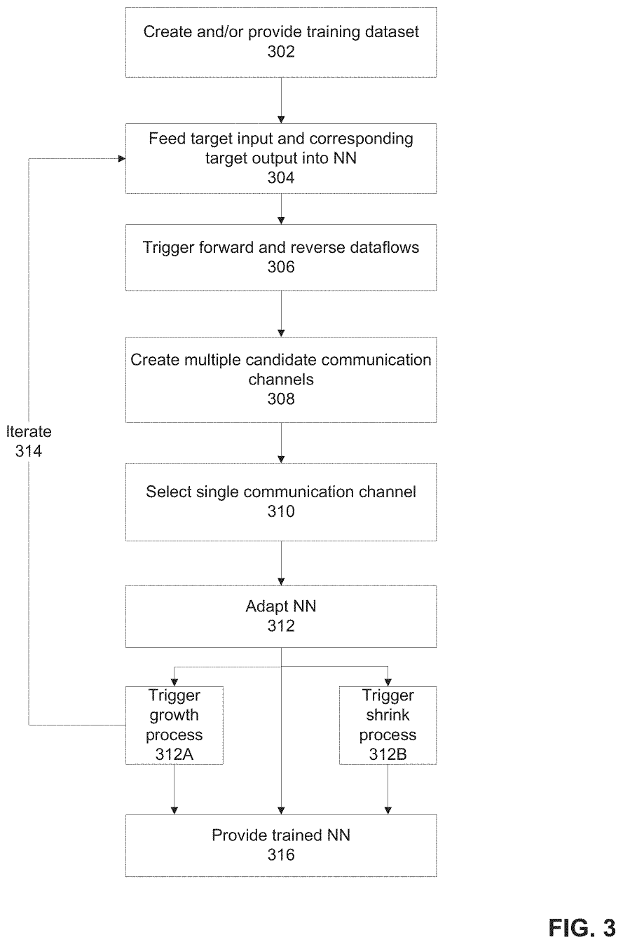

Reference is now made to FIG. 1, which is a block diagram of components of a system 100 for executing an inference process using a NN 108B and/or for training NN 108B, where the NN selects a single communication channel from candidate communication channels established by forward and non-forward dataflows, in accordance with some embodiments of the present invention. Reference is now made to FIG. 2, which is a flowchart of a method for executing an inference process using a NN, where the NN selects a single communication channel from candidate communication channels established by forward and non-forward dataflows, in accordance with some embodiments of the present invention. Reference is also made to FIG. 3, which is a flowchart of a method for training a NN for, where the NN selects a single communication channel from candidate communication channels established by forward and non-forward dataflows, in accordance with some embodiments of the present invention. System 100 may implement the acts of the methods described with reference to FIGS. 2-3, by processor(s) 102 of a computing device 104 executing code instructions (e.g., code 106A) stored in a memory 106 (also referred to as a program store).

Trained NN 108B maps computer inputs and/or physical sensory inputs to responses. The inputs into trained NN 108B are generated, for example, by processor based systems (e.g., client terminal 110, server 116, computing device 104, processor based system 150), and/or by sensing devices (e.g., sensor(s) 150A) that sense physical modalities (e.g., light, sound, touch, molecules, electrochemical parameters) and optionally convert their measurements to computer-readable form and/or sensors (e.g., code based sensors) that sense digital and/or virtual values. The output of system 100 and/or trained NN 108B are used, for example, to drive physical changes in system 150, and/or driver software based changes in system 150, optionally changes in control components 150B of system 150 (e.g., electro-mechanical components, software only components, computerized displays, 2D printers, 3D printers, holograms, motor commands to engines that move things in the world, sounds, molecule-emitting machines), and/or serve as inputs to other computer systems 100 and/or other trained NNs 108B.

Computing device 104 may be implemented as, for example one or more and/or combination of: a group of connected devices, a client terminal, a server, a virtual server, a computing cloud, a virtual machine, a desktop computer, a thin client, a network node, a network server, a mobile device (e.g., a Smartphone, a Tablet computer, a laptop computer, a wearable computer, glasses computer, and a watch computer), implemented in hardware, and/or code installed on an existing system (e.g., 150 or another system).

Different architectures of system 100 may be implemented, for example:
Computing device 104 may be installed within an existing system (e.g., 150 or another system). Exemplary systems 150 include: automatic vehicle, semi-automatic vehicle, intelligent agents, autonomic robots, computing systems, communication networks, production plants, robots, and device controllers.

Exemplary installation of computing device 105 within system 150 include, for example, an ECU installed in the automatic or semi-automatic vehicle, and code and/or hardware installed in the robot and/or computer system, and a plug-in (e.g. software and/or hardware based).
Computing device 104 may be in communication with the existing system (e.g., 150), for example, via a network 112 communication. For example, data outputted by sensor(s) 150A of system 150 is transmitted over network 112 to computing device 104, and instructions for controlling the control mechanism 150B (e.g., motors, navigation system, robotic arms) are transmitted from computing device 104 to system 150.
Computing device 104 may be implemented as one or more servers (e.g., network server, web server, a computing cloud, a virtual server, a network node) that provide services to multiple client terminals 110 and/or systems 150 over a network 112, for example, software as a service (SaaS), and/or other remote services.

Communication between client terminal(s) 110 and/or system 150 and computing device 104 over network 112 may be implemented, for example, via an application programming interface (API), software development kit (SDK), functions and/or libraries and/or add-ons added to existing applications executing on client terminal(s) 110 and/or system 150, an application for download and execution on client terminal 110 and/or system 150 that communicates with computing device 104, function and/or interface calls to code executed by computing device 104, a remote access section executing on a web site hosted by computing device 104 accessed via a web browser executing on client terminal(s) 110.
Computing device 104 may be implemented as a standalone device (e.g., vehicle, robot, kiosk, client terminal, smartphone, server, computing cloud, virtual machine) that includes locally stored code that implement one or more of the acts described with reference to FIG. 2-3.
Input signals 110A, and/or untrained NN 110B, and/or training dataset 110C may be stored at, for example, client terminal(s) 110, server(s) 116, system 150, and/or computing device 104. For example, server(s) may provide untrained NN 110B and training dataset 110C to computing device 104 for computing trained NN 108B, as described herein.
Trained NN 108B may be stored by computing device and/or server(s) 116 and/or client terminal(s) 110 and/or system 150.
Input signals 110A for inference by trained network 108B may be provided by, for example, system 150 and/or client terminal 110 and/or server 116. For example, input signals 110A are obtained as output of sensors 150A of system 150. Sensors 150A may sense physical phenomena, for example, for an autonomous vehicle, cameras capturing images of the road, sensors indicating speed of the vehicle, sensors indicating amount of fuel left in the vehicle, sensor indicating applied breaking force, and sensor indicating distance(s) to neighboring vehicles. Alternatively or additionally, sensors 150A may sense virtual and/or digital phenomena, for example, code that senses processor utilization, and amount of remaining free memory.

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-3 when executed by hardware processor(s) 102.

Computing device 104 may include data storage device(s) 108 for storing data, for example, code instructions of trained NN 108B, code for training the NN 108C, and/or training dataset(s) 110C, and/or input signals 110A. Data storage device(s) 108 may be implemented as, for example, a memory, a local hard-drive, virtual storage, a removable storage unit, an optical disk, a storage device, and/or as a remote server and/or computing cloud (e.g., accessed using a network connection).

Network 112 may be implemented as, for example, the internet, a local area network, a virtual network, a wireless network, a cellular network, a local bus (e.g., within the autonomous or semi-autonomous vehicle), a point to point link (e.g., wired), and/or combinations of the aforementioned.

Computing device 104 may include a network interface 118 for connecting to network 112, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 and/or client terminal(s) 110 and/or server(s) 116 and/or system 150 include and/or are in communication with one or more physical user interfaces 114 that include a mechanism for user interaction, for example, to provide and/or designate the data for classification, provide and/or designate output for training the NN, and/or a mechanism for viewing the output of the trained NN. Exemplary physical user interfaces 114 include, for example, one or more of, a touchscreen, a display, gesture activation devices, a keyboard, a mouse, and voice activated software using speakers and microphone.

Client terminal(s) 110 and/or server(s) 116 may be implemented as, for example, as a desktop computer, a server, a virtual server, a network server, a web server, a virtual machine, a thin client, and a mobile device.

Optionally, multiple systems 100 may be integrated together. Alternatively or additionally, two or more trained NNs are integrated together.

Systems 100 and/or trained NNs may communicate in two exemplary ways. In one implementation, the neurons of respective NNs are connected directly, creating a single system and/or single trained NN. In another implementation, the components of the system 100 and/or the trained NNs may use other input and/or output channels in order to communicate. Optionally, a modality that one system and/or NN uses as an output generates input in the other system and/or NN. For example, one system and/or NN may generate auditory signals, sensed as auditory inputs by the other system and/or NN. Similarly, systems and/or NNs may communicate through electronic channels (bit stream communication), assuming that they are capable of generating such bit streams as outputs and reading them as inputs.

A communication protocol may be hard-wired into the system and/or NN, or gradually evolved through simulation. Such a protocol may refer to as a language. When such inter-system and/or inter-NN communication is possible, the two or more systems and/or NNs may cooperate in executing a task. Learning processes are evoked to update (optionally all of) the participating systems and/or NNs. To facilitate this process, the systems and/or NNs may be hard wired to treat the satisfaction of the goals of another system and/or NN as a positive result. As a variant of this technique, hard-wiring may be performed for a selected subset of systems and/or NNs (e.g., systems and/or NNs that exhibit a particular feature, for example a certain ID or ID type). The system and/or NN may be hard wired in the opposite direction, such that the system and/or NN treats the satisfaction of the need of the other system and/or NN as something to prevent. This is useful, for example, in order to protect the system and/or NN against other systems and/or NNs that cause harm.

Referring now back to FIG. 2, at 202, a trained NN is provided. Alternatively or additionally, the NN is trained to create the trained NN. An exemplary method for training the NN is described with reference to FIG. 3. It is noted that acts 204-214 refer to the inference phase, during which the trained neural network is used to obtain output in response to input.

The NN may be implemented as a controller for control of a processor based system. The processor based system may include electro-mechanical components (i.e., including moving components), and/or may include only electrical/computer/software/firmware/circuitry components (i.e. no moving parts, without a mechanical component, only performing computation). The processor based systems may include one or more sensors. Examples of processor based systems including electro-mechanical components include: autonomous vehicle, semi-autonomous vehicle, autonomous robot, 2D printer, 3D printer, and combinations of the aforementioned. Exemplary outputs generated by the NN for such processor based electro-mechanical systems include: instructions for navigating the autonomous vehicle, instructions for navigating the semi-autonomous vehicle such as automated emergency maneuvers to prevent collisions or reduce impact, instructions for manipulating the autonomous robot, instructions for 2D printing by the 2D printer, instructions for 3D printing by the 3D printer, and combinations of the aforementioned. Examples of processor based systems that are computational only systems include, client terminals, servers, virtual machines, and mobile devices (e.g., smartphones, wearable computers).

The NN may be implemented as a hardware plug-in to the processor based system, a software code that is loaded to a memory of the processor based system for execution by the processor(s) of the processor based system, and/or integral to the processor based system.

The architecture of the trained NN is now described. The NN maps input signals, to an output response via neurons. The structure of the individual neurons may be based on neurons of standard neural networks. However, as described herein in additional detail, the neurons of the NN described herein are organized in unique clusters not found in standard neural networks, and the NN includes additional structure features not found in standard neural networks. Moreover, some neurons of the NN described herein perform functions not performed in standard neural networks.

Each individual neuron may have multiple outputs and/or multiple inputs, each of which may form multiple. Connections possess strengths (e.g., weights, capacities) that may be represented numerically.

Each neuron has an associated input value computed as an aggregation of one or more dataflows over one or more input connections according to the weights and/or capacities of the input connections and/or value of the dataflow(s). When the aggregated input value goes above a certain trigger threshold (called the activation threshold), the neuron is triggered. The triggered neuron outputs dataflow, resulting in further propagation of the dataflow to other connected neurons. Triggering reduces the aggregated input value for the respective neuron. The neuron may re-trigger until the aggregated input value falls below a stop threshold. Triggering frequency may depend on the speed at which the aggregation value of the certain neuron changes.

In some implementations, connections have aggregated values, and the aggregated value of the respective neuron is computed by summing the aggregated values of the connections of the neuron (e.g., the input connections). Such architecture provides for suppression of individual connections.

When a certain neuron is triggered, its output connections modify the aggregated value of their connected neuron targets. The amount of modification may be a function of the weight of the respective connection. The function may be, for example, linear, polynomial or exponential. Connections may increase the aggregated value of their targets for increasing likelihood of triggering further dataflow by the target neuron. Connections may decrease the aggregated value of their targets for decreasing likelihood of triggering further dataflow, conceptually inhibiting the target neuron. Some neurons may be designated as inherently triggered, which means that they may activate with no or very little input dataflow provided by other neurons.

Neurons that are included in the candidate communications channels are termed candidate channel neurons. The candidate channel neurons may be organized into clusters termed candidate channel clusters. As used herein, the term cluster alone generally refers to candidate channel clusters, unless the context of the term cluster refers to another type of mentioned cluster. Candidate channel neurons may be conceptualized as being stacked and/or arranged as respective sub-networks in each of the candidate channel clusters. Pairs of candidate channel neurons are connected by focused connections, i.e., one to one links. The candidate channel cluster of the NN described herein may be conceptually compared as corresponding to individual neurons of standard neural networks. The cluster architecture, which includes a sub-network of candidate channel neurons, provides a richer and/or more sophisticated architecture for deciding when an incoming signal(s) are propagated onwards (and when propagation is not continued), in comparison to the single neurons of the standard neural network.

Neurons located external to the candidate channel clusters for connecting between the candidate channel clusters are termed inter-cluster neurons. The inter-cluster neurons are optionally clustered into inter-cluster clusters. The terms inter-cluster neurons and inter-cluster cluster may sometimes be interchanged, for example, when referring to the structure that affects dataflow between candidate channel clusters. Each candidate channel cluster includes multiple intra-cluster connections between candidate channel neurons of the respective candidate channel cluster and multiple inter-cluster connections between candidate channel neurons of one or more other candidate channel cluster. The inter-cluster neurons perform the selection of the single communication channel from multiple communication channels, based on a competition process, as described herein.

Candidate channel clusters may be conceptualized as being arranged in a 2D space. In such a conception, a certain candidate channel cluster may connects to one or more other candidate channel clusters, which may be neighboring or non-neighboring candidate channel clusters, located far away. Such inter-cluster links may be, for example, short, medium, or long. A single cluster conceptually occupies a single location within the 2D space. Candidate channel neurons of the single cluster are conceptually stacked in one or more additional dimensions corresponding to the single location of the 2D space, for example, stacked vertically along a third dimension. Propagation of flow between clusters may be omnidirectional within the 2D space, enabling, for example, forward flow, and non-forward flow.

Optionally, the NN includes a separate cluster layer including long-distance candidate cluster outputs. For example, this layer may be the most superficial layer (L1).

Optionally, some neurons modulate the received input signals. The modulation may be performed, for example, to sustain the input signals (e.g., to allow sufficient time to set-up the candidate communication channels and/or select the single communication channel), to reduce the input signals (e.g., to avoid over flooding the neurons, in order to establish a reasonable number of candidate communication channels for selection of the single communication channel, where flooding may establish a large number of candidate communication channels making selection of the single communication channel difficult, impossible, and/or requiring long processing times).

Optionally, each candidate channel cluster includes candidate channel neurons selected from one or more types of content networks. Optionally, each candidate channel cluster includes neurons assigned to at least the input network (for receiving input) and the response network (for providing output). The following are exemplary types of content networks:
An input network having an architecture designed for receiving the input signals.
An alert network having an architecture designed for identifying input signals that do not trigger a hard wired response or a previously learned automated response for triggering an acute response
A decision making (DM) network having an architecture designed for executing the acute response by computing candidate communication channels and triggering selection of the single communication channel.

A focus network having an architecture designed for representing actions that are prepared or predicted to be executed in the near future.
A response network having an architecture designed for generating the single response outputs. The response network represents actions currently being executed.

It is noted that the input signals may be provided to other content networks, for example, the alert and/or response networks.

An example of including neurons from multiple content networks in the same candidate channel cluster includes: unifying the input network with the alert network for increasing response speeds. A cluster may contain many (e.g., dozens of) candidate channel neurons from the same network, and when it does, the candidate channel neurons may be normally tightly inter-connected.

Optionally, inter-cluster neurons are arranged into coordination networks of different exemplar types:
An execution coordination network (ECN), optionally including fast triggered inter-cluster neurons, that targets the execution networks (i.e., the focus network, the response network), the input network, and the alert network. The ECN includes inter-cluster neurons that target each other very strongly and strongly target neurons.
A competition coordination network (CNN) including (i) suppressive inter-cluster neurons that target the input connections of response network focus network and DM network neurons (ii) disinhibition inter-cluster neurons that target suppression inter-cluster neurons (iii) blanket inter-cluster neurons that target neurons in all networks (i.e., content and coordination). Suppressive inter-cluster neurons may target each other very strongly, and so may blanket inter-cluster neurons. Content neurons may target the inter-cluster neurons located near them. The AUX1 type and long-distance neuron outputs target the disinhibition inter-cluster neurons and blanket inter-cluster neurons.
A response suppression network (RSN) including inter-cluster neurons that directly suppress response network neurons. RSN neurons target candidate channel neurons just about before they output dataflow to strongly and rapidly suppress them. For example, the NN may learn that when inputs of a certain nature arrive, NN responses should be immediately stopped. As another example, the NN may be used to stop responses when arriving inputs show that there is some mistake in current responses.
a TRN network that allows to quickly suppress specific parts of the AUX1 clusters.

Content networks and/or co-ordination networks may be defined, for example, using one or more of the following exemplary processes:
In the initial state of the NN, before training, the NN may include all of the possible connections. The connections are then pruned if they are not used. Alternatively, the NN is initially instantiated with just those connections that are relevant.
During training, the neurons in each candidate channel cluster are sensitive to outputted T dataflow (i.e., a CT dataflow of a certain type is outputted to support the corresponding mode, and only the neurons in the content network that supports this mode are triggered by the CT dataflow type). Thus, dataflow is to a large extent determined by CT dataflow, in addition to the initial connectivity.
During training, new connections are formed as shortcuts of channels participating in the computation (i.e., new inter-cluster connections), and these connections further define the content and/or co-ordination networks.

It is noted that the content and/or coordination network are represented as being located in vertical stacks. (Note that the stack described herein is different than layers in standard neural networks). Response network candidate channel neurons normally have a wider input tree than candidate channel neurons in the other networks (i.e., their inputs have a wider extent and are connected to more neurons). The input, alert and response networks may be referred to as external networks. The DM and focus networks may be referred to as internal networks. The input, alert and DM networks may be referred to as the superficial networks. The focus and response networks may be referred to as deep or execution networks (in addition, the input network may have a deep component in layer 7 (L7)).

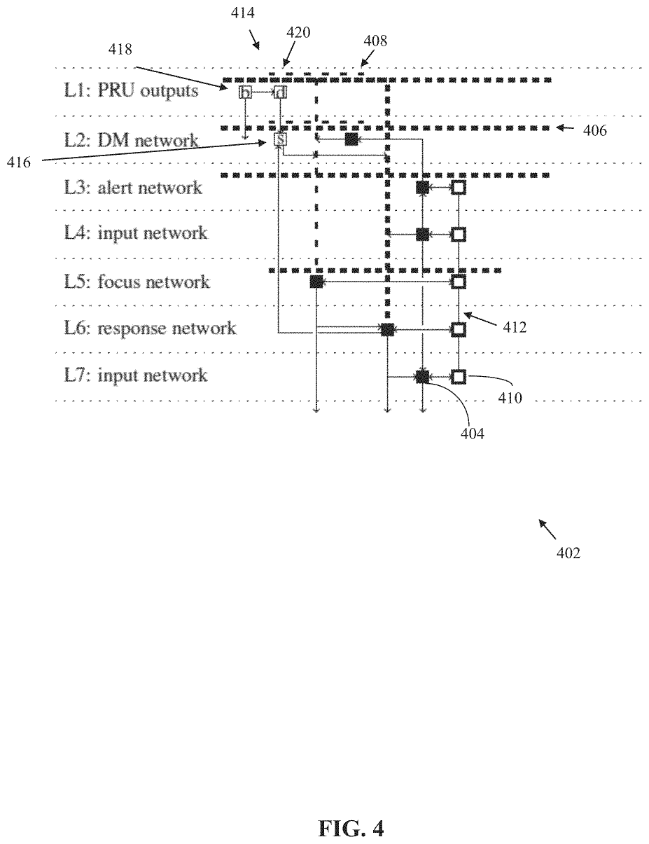

Reference is now made to FIG. 4, which is a schematic 402 depicting intra-cluster connections between content and coordination networks, in accordance with some embodiments of the present invention. It is noted that only the main patterns are shown. Inputs from auxiliary clusters and inter-node connections are not shown. The horizontal spacing between neurons is exaggerated. Filled squares (e.g., one 404 shown for clarity) denote candidate channel neurons. The wide (narrow) input tree of the response (focus) candidate channel neurons is shown in thick 406 (thin 408) dashed lines. Empty squares (e.g., one 410 shown for clarity) denote inter-cluster neurons. The execution coordination network (ECN) is represented by thick lines (e.g., one 412 shown for clarity). ECN interconnections are shown without arrows to emphasize that these may be ultra fast connections. The competition coordination network (CCN) 414 the following: suppressive inter-cluster neurons (box with s 416), disinhibition inter-cluster neurons (box with d 418), and blanket inter-cluster neurons (box with b 420). Blanket inter-cluster neurons target all candidate channel neurons (e.g., clusters) and inter-cluster neurons (e.g., clusters), depicted by a single general arrow. The deep networks have outputs to response units, AUX1, and AUX2 (the response network), to AUX2 (the focus network), and to AUX1 (the L7 input network).

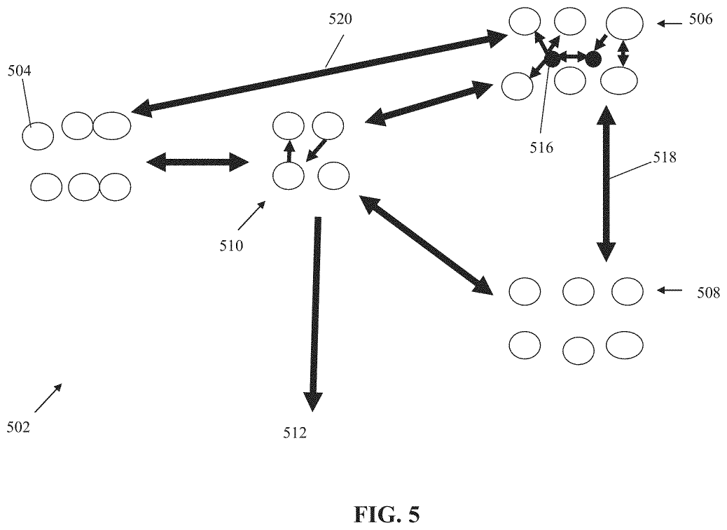

Reference is now made to FIG. 5, which is a schematic depicting an architecture of the NN 502, in accordance with some embodiments of the present invention. Empty circles (e.g., one circle 504 marked for clarity) represent clusters of candidate channel neurons. Filled circles (e.g., once circle 516 marked for clarity) represent inter-cluster neurons (which may be organized in clusters). Four general regions are depicted. Region 506 has an architecture designed for receiving sensory input of a certain type, for example, video outputted by an imaging sensor. Region 508 has an architecture designed for receiving sensory input of another type, for example, touch data outputted by a contact and/or touch sensor. Region 510 generates a certain type of output 512, for example low level motor output, for example, for steering an automated vehicle, controlling an amount of gas (e.g., gas pedal), and/or controlling braking (e.g., brake pedal). Region 514 generates higher level outputs controlling higher level goals, for example, controlling getting to the target destination. 514 may be triggered by focus network neurons pressing the vehicle to go forward (by connecting to appropriate neurons of region 510), or a navigation system is available (e.g., map, GPS), by focus network neurons representing the event “the vehicle is located in the destination location on the map”). Candidate channel clusters may be connected, for example, via short, medium, and long distance connections. Short connections may of clusters within a same region, for example, candidate channel clusters of 506. Medium connections may be of clusters between neighboring regions, for example, between 506 and 508 (e.g., represented by arrow 518), between 506 and 510, and between 504 and 510. Long connections may be between clusters of regions separated by other regions between them, for example, between 506 and 504 (e.g., represented by arrow 520). It is noted that connection 518 between 506 and 508 learns the association between video and touch inputs, and may perform mappings between video and touch inputs.

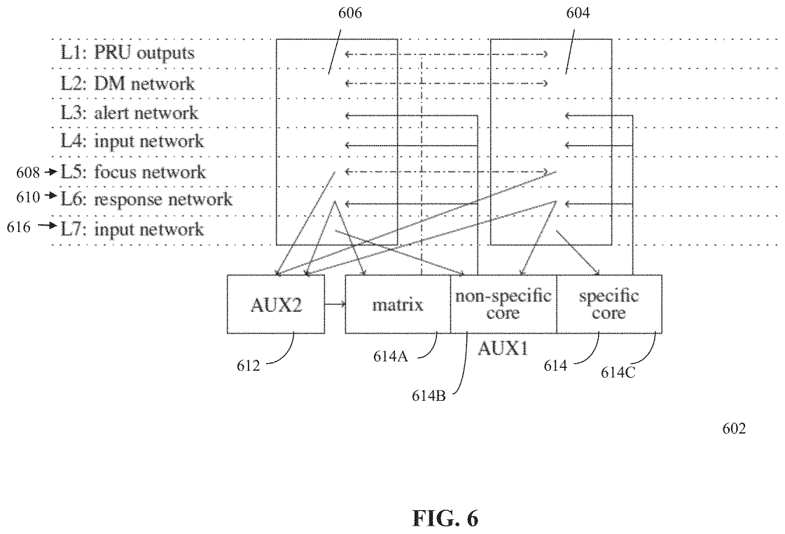

Reference is now made to FIG. 6, which is a schematic depicting two candidate channel clusters of NN 602, in accordance with some embodiments of the present invention. A primary input cluster 604 and Executive cluster 606 are depicted. Both the focus 608 and the response 610 networks connect to AUX2 612. The response network also connects to AUX1 614 (shown are the main such connections, Executive cluster 606 to AUX1 614 matrix 614A and primary input node 604 to non-specific core 614B). Input network L7 616 neurons connect to the AUX1 614 core that connect to their clusters. AUX2 612 connects to AUX1 614. Only the main AUX1-candidate channel cluster connection patterns are shown. The AUX1 matrix 614A diffusely connects to the internal networks of both clusters. AUX1 core connects to the external networks in a focused manner, the specific core 614C to the primary input cluster 604 and the non-specific core 614B to the Executive cluster 606. To prevent clutter, intra- and inter-node connections between the networks are not shown.

Referring now back to FIG. 2, at 204, input signals are fed into the NN. The input signals may be obtained and/or computed from sensors monitoring the processor based system. The sensors may monitor real-world and/or physical phenomena, for example, light sensors, motion sensors, vehicle speed sensors, geographical position sensors, images of the road ahead captured by an in-vehicle camera, and the like. The sensors may monitor virtual-world and/or computer-internal phenomena, and/or digital values, for example, amount of remaining free memory, data entered by a user, processor utilization, digital signature of an executing process, and a code segment extracted from memory.

Internal needs (e.g., energy, oils, battery) affect the NN, for example, by conveying internal-inputs that trigger candidate channel clusters. Similarly, candidate channel neurons that have recently been triggered usually remain in a state of a lower threshold of dataflow being required for re-triggering. In this manner, candidate channel clusters relevant for internal needs, and recently active candidate channel clusters, are more prone to participate in the emerging input-response mapping by the plurality of candidate communication channels.

Optionally, at least some candidate channel clusters represent (e.g., correspond to) a certain external entity by being activated when input indicative of the certain external entity is received and fed into the NN, and not activated when input indicate of other external entities is received and fed into the NN. A candidate channel cluster may represent an object or feature when the cluster's response network is activated when the object or feature emits input signals that generate dataflow into the NN, and if the cluster's response network is not activated by other objects or features. Such candidate channel clusters are either activated or not activated, as a whole, in response to the input indicative of the certain entity. In general, there may be several clusters representing a given object or feature, which means that damage to a cluster representing an object does not imply that the NN is incapable of addressing the object. In the same manner, a cluster represents a response (e.g., action) if its response network is activated when the response is executed and is not activated when the response is not executed. Representations may be hierarchical, because both NN-external objects (or features) and NN responses may be viewed at many levels of abstraction (e.g., the response of a robot ‘to make coffee’ is comprised of many lower level actions).

Optionally, when multiple content network types are implemented, the input signals are received by the input network, the alert network, and the response network.

Optionally, candidate channel clusters of the input network are primary input clusters of the following exemplary types, which are designed to receive certain types of input signals:
External-input clusters having an architecture designed for receiving entity-external inputs, including data from computing devices external to the processor based system and/or outputs of environmental sensors that sense an environment external to the processor based system, for example, visual sensors, auditory sensors, touch sensors, and smell sensors.
Internal-input clusters having an architecture designed for receiving entity-internal inputs including data from computing devices internal to the processor based system and/or outputs of system-internal sensors that sense internal parameters of the processor based system, for example, data from a management process, data indicative of battery state, data indicative of oil state, data indicative of desire to reproduce, and data indicative of level o proper functioning of components thereof.
Movement-input clusters having an architecture designed for receiving input from computing devices that control and/or sensors that sense a control mechanism of the processor based system, for example, speed sensors, tension sensors, and angle sensors.

The inputs are provided to the input network, and optionally at the alert and/or response networks. The input network triggers dataflow into the alert network and/or into the response network. The alert network triggers dataflow into the DM network and/or the input network in other candidate channel clusters. The DM network triggers dataflow into the focus network. The focus network triggers dataflow into the response network. Thus, the overall dataflow direction is input, alert, DM, focus, response.

It is noted that the behavior over time of the neural network when provided with input may be simulated. The simulation may be implemented as a main loop in which each iteration is dedicated to a single time slot. The smallest time slot may be the neuron trigger time. In each time slot, the aggregation value and trigger state of each neuron are updated by computing aggregation value and trigger functions. It is noted that the aggregated value of a neuron is reduced after several simulation steps, to prevent neurons from accumulating aggregated values over relatively long simulation time slots. Such accumulation may lead to erroneous results, because it confounds aggregated values that stem from different inputs. A reset mechanism may be used for resetting aggregated values of neurons even when not triggered.

At 206, the feeding triggers propagation of a forward dataflow in a forward direction from input to output and a non-forward dataflow in a non-forward direction from output to input. The propagation occurs as neurons and/or clusters receive input signals, and process the input signals to determine whether the respective neuron and/or cluster generates output (which is fed into another neuron(s) and/or cluster(s) or does not generate output, or what level of output is generated (e.g., amount, and/or value indicative of the output).

Optionally, non-forward dataflow is set-up by candidate channel clusters that receive the input signals, and have an architecture designed to propagate the dataflow in a non-forward direction, back towards the input signals, rather than in the forward direction towards the output.

The forward and non-forward dataflow are between candidate channel clusters.

Optionally, the non-forward dataflow occurs before the forward flow and/or simultaneously with the forward dataflow. The non-forward data flow occurs before the forward flow (in combination with the non-forward flow in the form of the candidate communication channels and/or the selected single channel) is propagated to produce an output result (as is done in standard NN training processes that use back propagation). Alternatively or additionally, the non-forward dataflow occurs after the forward dataflow. It is noted that the non-forward dataflow is in contrast to standard neural networks, where non-forward flow does not occur during the inference phase. In such standard neural networks, back propagation only occurs during the training phase, and such back propagation only occurs after the input has been forward propagated to the output layer of the neural network. The back propagation does not occur before the forward flow and/or simultaneously with the forward dataflow.

Optionally, at least some pairs of candidate channel neurons are bidirectionally connected by the forward dataflow flow and non-forward dataflow between each respective pair of candidate channel neurons. Forward flow and non-forward flow may occur between the pair of connected candidate channel neurons.

Optionally, at least some bidirectional connections between respective pairs of candidate channel neurons are unbalanced. Optionally, forward dataflow is significantly larger (e.g., has a relatively higher weight and/or value) than the non-forward dataflow.

The non-forward dataflow may synchronizes activation of the respective pair of candidate channel neurons. The forward dataflow may recruit additional candidate channel neurons to the candidate pool.

Optionally, dataflow occurs between different content network types, according to the following exemplary architecture:
The input network triggers dataflow into the alert network and the response network.
The alert network triggers dataflow into the DM network and candidate channel neurons belonging to the input network in candidate channel clusters.
The DM network triggers dataflow into the focus network.
The focus network triggers dataflow into the response network.

The main overall dataflow is from input network to alert network to DM network to focus network to response network.

Optionally, candidate channel neurons of different candidate channel clusters and of a same network content type triggers dataflow into each other.

Optionally, at least some candidate channel clusters are arranged as an executive area. The forward dataflow is from primary input candidate channel clusters to the executive area. The non-forward dataflow is from the executive area to other candidate channel clusters. Another dataflow flows between different primary input candidate channel clusters. In the executive architecture, the general direction of dataflow in the input and alert networks is in a forward direction, while that in the DM and focus networks is in the non-forward direction. In addition, there may be inter-network connections, mostly between deep networks in one cluster and superficial networks in another cluster. Such architecture enables responses made by low level (i.e., closer to system input) clusters to convey flow to the DM network in higher level clusters, prompting longer-term response strategies, and long-term tasks prepare responses in lower-level clusters (e.g., related to predictions, as described herein).

Input signals into the NN convey strong dataflow into primary input nodes, triggering further dataflow for their input and alert networks. Since the alert network triggering further dataflow in other clusters, the input signals into the NN may induce triggering further dataflow of input and alert network neurons in other clusters. In addition, the input signals may trigger further dataflow in the response network, which triggering further dataflow in core non-specific AUX1 neurons (as described below). In turn, triggering further dataflow into the input, alert and response networks in other clusters. The input signals trigger dataflow propagation in two routes (candidate channel clusters to candidate channel clusters, and candidate channel clusters to type-1-auxiliary-clusters to candidate channel clusters) in the forward flow and associative directions. When not prevented by competition (as described herein), the propagating forward dataflow flow is met by DM flow in the non-forward direction and/or contra-associative direction. In both cases, candidate channel clusters that receive sufficiently strong dataflow have their response network neurons triggered for generating the output response.

Optionally, an input mode is initially triggered, in which input signals are received, and dataflow is propagated through the input network. Pre-defined inputs may trigger hard-wired responses. When hard-wired responses are not triggered, the input may trigger an automated response. Automated responses are adaptive responses that have been thoroughly learned. When automated responses are not triggered, the system generates an acute response, via several modes, as described herein. The acute response establishes multiple communication channels from which a single channel is selected, as described herein.

At 206A, auxiliary clusters of neurons, located external to the candidate channel clusters of candidate channel neurons described herein, are triggered by the dataflow resulting from the input signals.

The auxiliary clusters may provide a feedback loop to stabilize the generated responses, for example, to sustain the dataflow to allow sufficient time for setting up the candidate communication channels and selection of the single communication channel, and/or for sustaining the single communication channel for sufficient time to allow implementation of the outputs by the processor based system. For example, in some cases, without the auxiliary clusters, the dataflows may be short lived, not enabling sufficient time for setting up the candidate communication channels and selection of the single communication channel.

Optionally, four types of exemplary auxiliary structures are defined, denoted herein as type-1-auxiliary-clusters (also referred to as AUX1), type-2-auxiliary-clusters (also referred to as AUX2), type-3-auxiliary-clusters (also referred to as AUX3), and type-4-auxiliary-clusters (also referred to as AUX4). Each auxiliary structure includes neurons designed to generate certain output when fed by certain dataflow.

The AUX types are briefly summarized, and then discussed in greater detail below. AUX1 and AUX2 work together. AUX neurons do not necessarily span the full set of content networks, and may show different inter-neurons connectivity. The main difference between the AUX operation and that of the candidate channel neurons and/or the inter-cluster neurons that connect between the candidate channel clusters, is that the AUXs use an inherently active set of neurons that suppresses responses, and another set that suppresses this first suppressive set. Hence, the effect of triggering the second set is to disinhibit (i.e., allow) responses. (AUX1 does not have a continuously active set, but it works with AUX2, which does, so AUX2 continuously suppresses AUX1, which in some scenarios is needed, for example, for sustaining system responses). For example: focus and response network neurons target AUX1 and AUX2 neurons, recruiting them during the response computation process just as the candidate channel neurons and the inter-cluster neurons connecting between candidate channel clusters are recruited. When a response is formed, in addition to candidate channel neurons and the inter-cluster neurons, it includes a communication channel via AUX1 neurons and/or AUX2 neurons. The channel via AUX1 and AUX2 neurons “triangulates” the response to provide it with greater stability. In another example, AUX3 neurons may continuously inhibit responses to certain hard-wired inputs. When such input signals are received, responses are rapidly disinhibited. This is useful when rapid responses are needed. For example, when the NN controls a vehicle that is about to collide with something, and it has a hard-wired response that presses a brake when it gets too close to a physical object while moving in its direction. For this response to be processed very quickly, a “disinhibition” connectivity is preferred over the normal connectivity via candidate channel neurons and inter-cluster neurons, in which the number of connections and timesteps to reach a response are larger. AUX4 is like AUX3, but it is preferably used to disinhibit (i.e., allow) learned (rather than hard-wired) responses.

Type-1-auxiliary-clusters has an architecture designed for providing candidate channel clusters and/or inter-cluster neurons with input dataflow, and/or for sustaining triggered activation of the candidate channel neurons of the candidate channel clusters and/or inter-cluster neurons connecting the candidate channel clusters. The architecture of the type-1-auxiliary-clusters is designed for activation by the response network and by a deeper part of the input network.

Optionally, the type-1-auxiliary-clusters include a core portion and a matrix portion. Neurons of the core portion connect to the input network, to the response network, and to the alert network, optionally in a spatially focused manner. Neurons of the matrix portion connect to the DM network, to the alert network, to the focus network, to the response network, and to the competition coordination network in a more extended diffuse manner. The spatially focused manner refers to providing dataflow to a smaller specific target set of neurons. The diffuse manner refers to providing dataflow to a target set of neurons that is not focused, but more diffuse, for example, providing dataflow to one or more central neurons with a diminishing amount of dataflow reaching neurons that are increasingly further away from the central neurons.

The core portion includes a specific sub-portion and a non-specific sub-portion. The specific sub-portion includes neurons for receiving system input dataflow of a defined type, and/or for conveying the input dataflow to primary input clusters. The non-specific sub-portion has an architecture designed for conveying the input dataflow to other clusters.

Type-2-auxiliary-clusters have an architecture designed for controlling access of the candidate channel clusters to the type-1-auxiliary-cluster.

The type-2-auxiliary-cluster include includes inhibitory input neurons and/or inhibitory output neurons. The inhibitory neurons have an architecture designed to prevent dataflow from triggering the target neuron they are connected to. The inhibitory output neurons have an architecture designed for continuous suppression of the type-1-auxiliary-cluster. The inhibitory input neurons have an architecture designed for targeting the inhibitory output neurons.

To obtain access to the type-1-auxiliary-clusters by candidate channel clusters of candidate channel neurons, the candidate channel clusters of candidate channel neurons trigger the inhibitory input neurons of the type-2-auxiliary-cluster using the focus network and the response network for disinhibiting the neurons of the type-1-auxiliary-cluster, which disinhibits the neurons of the type-1-auxiliary-cluster. A candidate channel cluster to type-2-auxiliary-cluster to type-1-auxiliary-cluster to candidate channel cluster connection channel (e.g., loop) is created. The created channel sustains activation of intra-neurons of the candidate channel clusters.

The type-2-auxiliary-cluster may include additional internal inhibitory neurons and/or triggering neurons (i.e., neurons that provide dataflow), for controlling and/or sustaining neurons of the type-2-auxiliary-clusters, of the same the type-2-auxiliary-cluster cluster and/or other the type-2-auxiliary-cluster clusters.

Type-3-auxiliary-clusters have an architecture that includes AUX3a and AUX3b components. The AUX3a components includes subset of neurons that are non-inherently active inhibitory, and connect to the AUX3b component. The AUX3b component includes a subset of neurons that are inherently active inhibitory for suppressing responses. Neurons that trigger AUX3a component neurons inhibit AUX3b component neurons and/or disinhibit responses (i.e., outputs). The type-3-auxiliary-clusters is similar to the type-2-auxiliary-clusters, but in the type-3-auxiliary-clusters the disinhibited neurons drive responses rather than the candidate channel clusters as in type-2-auxiliary-clusters.

Type-4-auxiliary-clusters have an architecture that includes a AUX4a component. Neurons of the AUX4a components are designed to be inherently active inhibitory for continuously suppressing output neurons of the type-4-auxiliary-cluster that drive responses (i.e., outputs). Neurons suppress the AUX4a, neurons of the type-4-auxiliary-cluster outputs are disinhibited for execution.

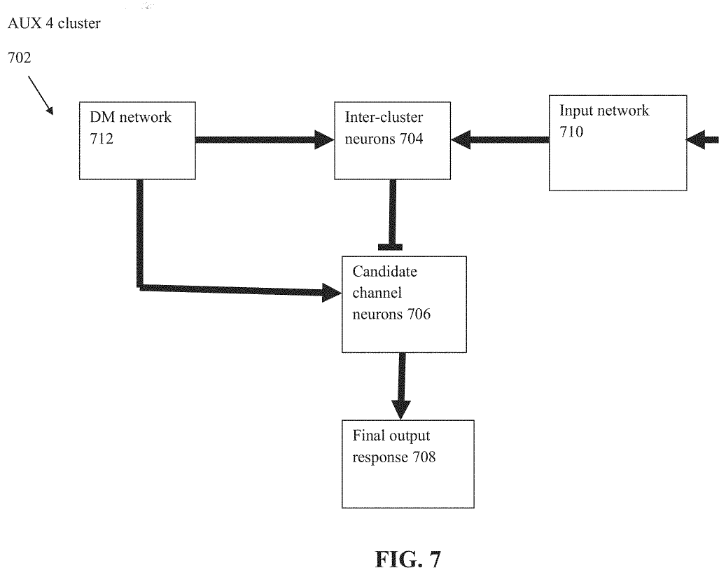

Reference is now made to FIG. 7, which is a schematic depicting an exemplary architecture of a type-4-auxiliary cluster 702, in accordance with some embodiments of the present invention. Region 704 includes continuously (e.g., inherently) active inter-cluster neurons, which inhibit response candidate channel neurons 706, which trigger the final output responses 708. Region 704 receives dataflow by both the input network 710 and the DM network 712. When the two dataflows converge on the same inter-cluster neuron of 704, they suppress it to disinhibit a specific response in candidate channel neurons 706. DM network 712 outputs dataflow to candidate channel neurons 706 to save time and ensure the selection of the correct response by candidate channel neurons 706.

Referring now back to FIG. 2, at 206B, propagation forward dataflow and/or non-forward dataflow is modulated by neurons arranged in multiple connection type (CT) clusters. The CT clusters are external to the candidate channel clusters (of candidate channel neurons). Each CT cluster has an architecture and connectivity for modulating a target set of candidate channel neurons of one or more types of content network via CT dataflow provided by the CT cluster to the target neurons. For example, one CT cluster has an architecture and connectivity for modulating the DM network and the response network, and another CT cluster modulates the DM network only.

Each CT cluster has neurons that provide the CT dataflow to the candidate channel neurons (and/or clusters thereof) and/or to the inter-cluster neurons that connect between the candidate channel clusters, and/or inter-cluster neurons that coordinate CT dataflow outputted by neurons of the CT clusters.

The CT clusters are external to the candidate channel neurons (and/or clusters thereof) and/or to the inter-cluster neurons that connect between the candidate channel clusters.

CT dataflow, which is outputted by neurons of the CT clusters, is triggered by triggering of candidate channel neurons (e.g., assigned to the response network), by other CT cluster neurons, and/or by neurons of auxiliary clusters (e.g., any of the four types described herein). In other words, CT cluster neurons may be triggered by any other neurons of the NN.

Some CT cluster neurons are continuously active, affecting their CT dataflow continuously, for example to ease responses.

Modulation affects the response of the candidate channel neuron to the same amount of dataflow. For example, by reducing or increasing a threshold of the amount of dataflow required to further propagate dataflow by the respective neuron. For example, one type of modulation reduces the threshold, such that the same amount of dataflow which previously did not trigger the neuron to further propagate the dataflow, now triggers the neuron to propagate the dataflow. In another example, another type of modulation increases the threshold, such that the same amount of dataflow which previously triggered the neuron to further propagate the dataflow, no longer triggers the neuron to propagate the dataflow.

The connections between the CT clusters and candidate channel clusters of candidate channel neurons is a diffuse connection, where a set of multiple target candidate channel neurons are affected by CT dataflow from the CT cluster. CT clusters target a set of candidate channel neuron input and/or output connections. CT dataflow over a single diffuse connection outputted by the CT cluster (i.e., by CT-neurons thereof) is received by multiple target candidate channel neurons. It is noted that such diffuse connection is in contrast to the one-on-one focus connections between candidate channel neurons and/or extra-cluster neurons, where dataflow over a focus connection is received only by the single target neuron of the respective connection.

Optionally, CT dataflow outputted by the CT clusters has a diffuse effect on the target set of candidate channel neurons. The CT dataflow outputted by the CT clusters changes over space, by having a relatively stronger modulation effect at a center of the target neurons and a diminishing modulation effect with increasing distance from the center. Modulation of connections of the target set of candidate channel neurons occurs as a function of a space of the NN. The space may be defined, for example, as a virtual distance such as by arranging the candidate channel clusters and/or intra-neurons in a virtual 2D and/or higher dimensional space, and/or as a space based on conceptual distances between intra-neurons such as how many intermediate neurons are between any two intra-neurons. Optionally, a relatively stronger CT dataflow generated by the respective CT cluster arrives at a certain centralized location of each one of the target set of candidate channel neurons of the respective type of content network. The centralized location of candidate channel neurons is modulated to a greater degree than candidate channel neurons located further away. The modulating effect diminishes with increasing distance away from the centralized location. The term center may denote a real spatial sense (when neurons have associated physical locations), or an abstract sense (when the center and inter-neurons distances are represented by other means, e.g., symbolically, statistical distances, or via a general function).

Optionally, the modulation effect of the CT dataflow changes over time. The amount of CT dataflow and/or the modulation effect may diminish after the initial CT dataflow (e.g., during the simulation time slots).

The diminishing effect of CT dataflow over time and/or space may be, for example, linear, polynomial, and/or exponential decay.

Optionally, CT dataflow for modulation outputted by respective CT clusters is triggered by a combination of one or more of: candidate channel neurons of the candidate channel clusters of the NN, neurons of the CT cluster, neurons of other CT clusters, and neurons of at least one auxiliary cluster type.

Optionally, there are different types of CT clusters that provide different types of CT dataflow. Candidate channel neurons may be modulated by one type of CT dataflow, or multiple types of CT dataflow originating from CT clusters of different types.

Optionally, the relationship between which candidate channel neurons are modulated by which CT dataflow types is defined by markings associated with the connections. The markings may be virtual tags and/or virtual labels. Connections in the NN are marked by the set of CT dataflow types that may target them. Each connection may be marked to be modulated by more than one CT dataflow type. Several modes may affect the same connection. There may be several sub-types of markings for each CT dataflow, such that a single CT dataflow type may have different effects on its target connections. For example, one marking sub-type may trigger the connection's target, while another sub-type may suppress the connection's target. There may be markings on the CT cluster connections themselves, for example, providing for self-modulation feedback and/or cross CT dataflow type modulation.

Optionally, a modulation effect obtained in response to CT dataflow of the CT clusters is according to a respective affinity parameter associated with respective connections of the target set of candidate channel neurons. The affinity parameter may be associated with the marking defining which CT dataflow types modulate the respective connection. The affinity parameter may affect the modulation for triggering a corresponding output dataflow by respective the candidate channel neuron, according to an amount of CT dataflow from the respective CT cluster. For example, relatively high affinity markings are triggered in response to relatively low CT dataflow from the respective CT cluster for providing a relatively low threshold for triggering the corresponding dataflow in the respective candidate channel neuron. Relatively low affinity markings are triggered in response to relatively high CT dataflow from the respective CT cluster for providing a relative high threshold for triggering the corresponding dataflow in the respective candidate channel neuron. The amount of CT dataflow may be determined, for example, by frequency of triggering of the CT clusters, by weights of the CT dataflow, and by spatial and/or temporal decay functions (i.e., distance from center, and/or over time, as described herein). For example, large CT dataflow (e.g., as typically generated in surprising situations and/or in situations in which an urgent response is needed) tend to activate low-affinity markings, and conversely, small flow (e.g., typically generated during automated situations) tends to utilize high-affinity markings.

The neurons of the candidate channel clusters and inter-cluster neurons (and/or clusters) are assigned to content networks. The content networks are ordered (i.e., input, alert, DM, focus, response). Each network corresponds to a certain mode in which the respective network and preceding networks are active, computing which neurons belonging to subsequent networks would trigger.

For example, in the “alert” mode, sensory input signals trigger the input network, which triggers the alert network (the precise triggered candidate channel neurons are determined by where the input arrives and by the current state of the connections between the networks). The goal of the triggering is to activate the DM network. When this happens, the DM mode is triggered, whose goal is to decide which focus and response neurons would activate. Eventually, the arriving inputs trigger a subset of response network candidate channel neurons. In this way, the NN computes an input-output mapping represented by the candidate communication channels and/or the single communication channel, as described herein.

Some modes have a preferred dataflow direction. In general the input and alert modes yield dataflow from the input onwards (i.e., forward direction), while the DM and focus modes involve non-forward dataflow. The response mode generates output so it is not forward or non-forward. However, it is noted that candidate channel neurons in the same network are interconnected, which means (for example) that response network neurons may generate forward and/or non-forward flow within the NN.

Optionally, modes are triggered by CT clusters of different types. Each mode is based on a different combination of content networks. Each mode is associated with a set of CT dataflow types outputted by corresponding CT clusters of respective types. Conceptually, a candidate channel neuron that is triggered by the CT dataflow releases the CT. Some or all of the candidate channel neuron that release a certain CT dataflow are triggered (by other candidate channel neuron) to promote the certain mode assisted by the corresponding CT dataflow type. CT dataflows may affect candidate channel neuron and/or connections. CT dataflows affect candidate channel neurons, for example, by modifying their charge, and affect connections for example, by modifying their weights. Other exemplary modification are described with reference to training of the NN.

It is noted that a single CT dataflow and/or a single CT dataflow type may affect a whole area of candidate channel neurons for promote its mode. The effect is spatially and/or temporally restricted to allow the operation of other types of CT dataflows and modes.

CT dataflow types assist their respective modes due to the fact that their markings are located in candidate channel neurons belonging to the content networks affected by the CT dataflow type's mode. For example, alert CT dataflow types promote the alert mode via low-affinity markings located on candidate channel neurons in the alert network, which put their candidate channel neurons in a state of prolonged excitation. Alert CT dataflow types may also suppress the responses executing just before the alert via high-affinity markings located on the response network, which activate intra-neuron processes that suppress the candidate channel neurons.

Exemplary dataflow based on activated modes is now described. Initially, the NN is in input mode, in which input signals are received and dataflow is triggered through the input network. When no hard-wired and no automated responses are triggered, the input signals trigger dataflow through the alert network to yield the alert mode. The alert mode may trigger execution of three exemplary tasks (one, two, or all three, or combinations thereof). First, it is hard-wired to responses that allow the NN to receive more detailed inputs relevant to the situation. For example, these responses may adjust orientation of input devices (e.g., cameras, microphones) to better capture the situation and provide higher quality and quantity input signals. Such process may be termed orienting of attention (OOA). Second, the alert mode triggers responses that recruit entity-internal (agent-internal) resources to better deal with alerting situations. For example, these responses may include the provision of additional electric energy to components of the processor based system and/or of the NN that need it, usage of additional NNs, additional components of the processor based system and/or neurons, warming up motors that drive movements, and the like. Third, the alert mode may trigger activation of the DM network. That is, as long as there is input dataflow that is not answered by hard-wired or automated responses, the alert network triggers the formation of acute responses to such dataflow.

The DM network is triggered during the DM mode. It contains candidates from which responses are eventually selected. It is vertically triggered by the alert network and horizontally triggered by the DM, response and focus networks using a non-forward dataflow direction. In particular, when alert dataflow reaches higher-level clusters, it triggers their nodes' DM network, which triggers the DM network in lower-level clusters via intra-network connections. These connections exist because they were useful in the past (because learning strengthens connections that are used in input-response mappings). Thus, the DM network in clusters representing past responses made to some of the inputs signals (i.e., to input features) is triggered. This creates a pool of candidate communication channels, from which a focused response in the form of the single communication channel emerges via competition (e.g., as described with reference to acts 208-210).

There may be two types of DM mode, for example, supporting urgent and non-urgent (planning) responses, which are supported by different CT dataflow types. The urgent mode involves competition (i.e., selection of one channel from multiple candidate communication channels, as described herein), while the non-urgent mode supports longer term planning before a response is made. The planning CT dataflow may suppress predefined need-induced dataflow and responses, and promote the DM network, without suppressing motivating need-induced dataflow and planning-related responses.

The focused execution mode, also termed focus mode, utilizes the focus network and the response network. Its operation is described in further detail herein.

At any time, the alert mode may be terminated by the interaction mode. For example, when new information (new input signals) indicates that the situation does not require an acute response. For example, when a surprising object turns out to be non-threatening. In this case, the NN may generate responses that promote interaction with the object or ignore it. Note that interaction may be a useful strategy, because it lets the entity managed by the NN learn more about the object or exploit unforeseen opportunities.

At any time, the mistake mode may put a rapid brake on focused execution and returns the NN to DM mode. For example, when new input signals indicate that the current response is not a good one, but the input still requires a response. Entities may consume resources (e.g., energy, spare parts, and the like) during operation. To take the changing conditions of internal resources into account, the alert mode may continuously promote the vigilance mode, which may slow down resource utilization and response execution. The vigilance mode may continuously trigger the resolution mode. When certain resource thresholds have been reached, the resolution mode terminates vigilance and focused execution. If NN input signals requiring a response persist, the newly computed responses would take into account the available resources (as usual), because they have information about them via internal-inputs that are taken into account during DM. The resolution mode normally promotes hard-wired responses via its suppression of adaptive responses. Focused execution may utilize hard-wired responses when it gets close to achieving its goals. In this case, hard-wired responses are used for termination of the process.

It is noted that triggering modes may involve the execution of a large number of intermediate responses. For example, the alert mode works as part of other modes by generating responses that increase the availability of internal resources. A useful NN feature is to allow response neurons to modulate NN input signals. Here, modification of the way that input signals are received is a type of response. It is possible to add this capability to response neurons that affect other types of responses, or to have response neurons specializing in this response type. As an example, it is useful to have response neurons that target neurons conveying movement-inputs such that the latter's activation rate is in direct correlation with the response neuron's activation rates. This way, if the response neurons do not activate, there are no movement-inputs (response neurons may also be configured in the opposite way). In the common case in which system connectivity is such that movement-inputs are essential for generating motor movements, response neurons may be used to stop movement quickly (e.g., when surprises occur) or to prime movement before it actually starts (e.g., during movement planning in the decision making (DM) mode).

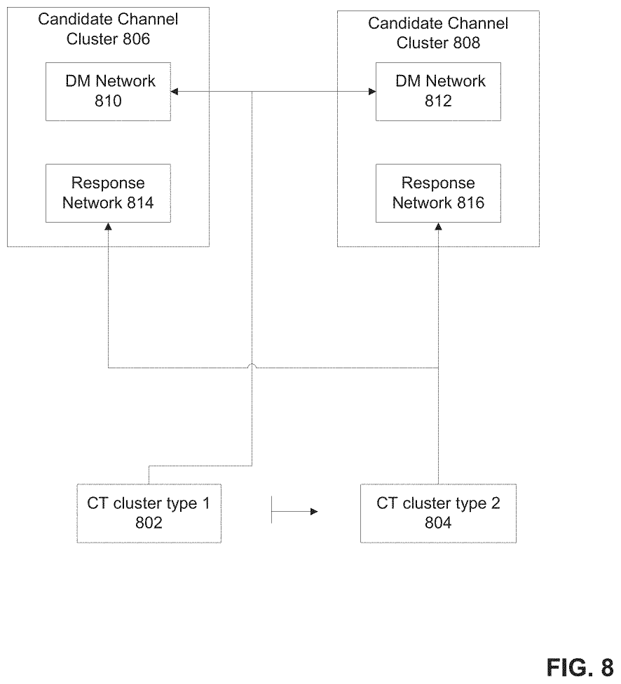

Reference is now made to FIG. 8, which is a schematic depicting two CT clusters 802 804 of different types (denoted herein as type 1 and type 2 respectively), in accordance with some embodiments of the present invention. CT clusters 802 804 provide CT dataflow of type 1 and type 2 respectively, to candidate channel clusters 806 and 808. CT cluster 802 triggers CT type 1 dataflow in DM network 810 of cluster 806, and DM network 812 in cluster 808. CT cluster 804 triggers CT type 2 dataflow in response network 814 of cluster 806, and response network 816 in cluster 808. The CT dataflow types assist triggering the modes they correspond to, i.e., CT dataflow type 1 triggers the DM mode, and CT dataflow type 2 triggers the response model. CT dataflow type 1 may trigger CT dataflow type 2, for example, in order to speed up (e.g., reduce computational time to obtain) responses. CT dataflow type 2 may suppress (i.e., reduce triggering of dataflow by) CT dataflow type 1, for example, after a response has been selected, triggering of the DM networks is suppressed to trigger the candidate channel clusters that are included in the selected single communication channel.

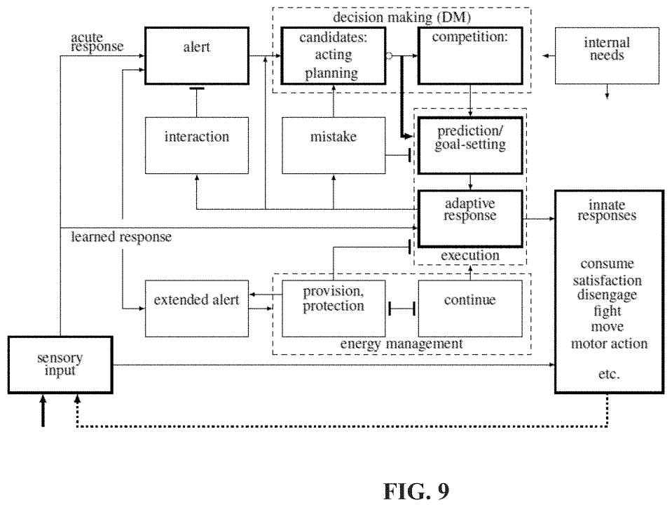

Reference is made to FIG. 9, which is a dataflow diagram depicting exemplary dataflow for triggering modes, in accordance with some embodiments of the present invention. Arrows indicate triggered dataflow. T endings indicate suppression inherent to a mode's role (general inter-mode suppression is not shown). Only the main connections are shown. Internal needs (and recent history) provide general neuron triggering and suppression to guide responses. The modes associated with the acute response are denoted by thicker rectangles. Example responses include: consume, satisfaction, disengage, fight, move, and motor action. Also shown is an extended alert mode and example energy management modes including provision, protection from reduced energy, and continue.

Referring now back to FIG. 2, at 208, multiple candidate communication channels are established from the forward dataflow and the non-forward dataflow. Each candidate communication channel is a mapping from input signals to one or more candidate outputs. Each candidate communication channel is established by candidate channel clusters that participate in the forward and/or non-forward dataflow. Each candidate channel cluster is considered as a whole, arising from interaction of the intra-neurons therein, meaning that each candidate channel cluster either participates in a certain (one or more) candidate communication channel, or does not participate in any candidate communication channel. A candidate channel cluster cannot partially participate in a certain candidate communication channel.

The candidate communication channels may overlap, may occur as branches, and/or may be independent.

The candidate communication channels may be established based on associative dataflow that denotes associations between different input signals generated in response to a common input object.

Optionally, the candidate communication channels are established when dataflow has not been hardwired and/or has not been previously fully learned (i.e., to establish a virtual hardwiring) also referred to herein as adaptive responses. The candidate communication channels represent candidate outputs in response to the same input signals, for example, possible courses of action an automated vehicle may take in response to receiving an image of an oncoming vehicle indicating risk of collision. For example, the vehicle may swerve to the left, swerve to the right, or brake. The hardwired responses represent pre-programmed responses that cannot be altered, and which do not require resolution. Hard-wired responses are, for example, candidate channel neuron connections that are triggered by pre-determined input types (e.g., single inputs, combinations of multiple inputs). The previously learned responses represent responses for which the NN has been previously trained (e.g., multiple times, or trained precisely once) and for which the output has been sufficiently mapped to the input, for example, a single channel is automatically setup between input and output based on the training rather than multiple channels. As such, the candidate communication channels conceptually represent a decision point between different possible outcomes.

When a hard-wired response is executed, some of the hard-wired neurons implementing the hard-wired response trigger adaptive neurons (in some implementations, the NN location in which this occurs is AUX3 cluster(s)). Such as scenario triggers the adaptive NN to learn the situations in which specific hard-wired responses are triggered. This is useful in two exemplary ways. First, it lets the adaptive NN take into account hard-wired responses during planning (e.g., the DM mode, as described herein). This way, hard-wired responses guide the NN towards the valence (value) of specific situations. For example, if some predefined NN input triggers a ‘consume’ hard-wired response (e.g., as described herein), adaptive responses whose goal is consume automatically seek this type of input. Second, it lets the hard-wired NN be extended by associating inputs that are not hard-wired to any response with a specific hard-wired response. Executed responses usually channel flow in a narrow, focused manner, preventing it from reaching candidate channel neurons that may yield other responses. However, if the NN's inputs persist arriving after the execution of a response, such channeling may not be effective. In this case, persistent inputs may trigger a higher level response (i.e., automated or acute after hard-wired, or acute after automated).

It is noted that even in the presence of some hardwired connections and/or some previously learned connections, the candidate communication channels may be established when a single channel is not created between input and output due to the presence of some connections which are not hard wired and/or have not been learned and/or have not been sufficiently learned.

The multiple candidate communication channels may be generated based on output of one or more of the content network types. For example:
The alert network may triggers one or more of (i) instructions for receiving additional inputs from additional devices monitoring the system (ii) output for controlling system-internal controls, and (iii) dataflow into the DM network for triggering an acute response. Each one of the options may be part of a candidate communication, or define its own candidate communication channel, or set-up a single communication channel without first setting up the candidate communication channels, for example, setting up an acute response based on hard-wired and/or pre-learned established connections.
The DM network has an architecture designed for triggering an urgent response based on a process for selecting the single communication channel from the multiple candidate communication channels. Alternatively, the urgent response may set-up the single communication directly without first setting up the candidate communication channels. The urgent response is designed to provide a fast output in response to certain input, for example, for a real time system such as an automated aircraft and/or automated vehicle. Urgent response may be required in certain situations where a delay in obtaining output may be detrimental, for example, avoiding collision. Alternatively or additionally, the DM network has an architecture designed for triggering a non-urgent response based on additional recruitment of candidate communication channels before the single communication channel is selected. The recruitment is performed by including a sub-set of inter-cluster neurons that suppress certain dataflow and do not suppress other dataflow. Non-urgent response may be designed to be triggered where the optimal response is preferred rather than an urgent response, and where a delay is not necessarily a factor, for example, a robotic arm deciding the best way to pick up a valuable and/or breakable object. Deciding how to position the robotic arm to safely pick up the object is preferred, even when a time delay is incurred, rather than urgently picking up the object with risk of breakage.

Each of the urgent response and non-urgent response is triggered by differential responses to the forward and non-forward dataflow.

Optionally, one or more of the candidate communication channels represents a detected error. Alternatively, a single communication channel is created based on the detected error. The error may be detected based on a burst of high frequency sequence of candidate channel neuron signals generated when a non-triggered certain candidate channel neuron is triggered. The burst trigger of the certain candidate channel neuron generates higher dataflow when a previous state of the certain candidate channel neuron is non-triggered than when the previous state is partially or fully triggered. During an error situation the bursts are indicative of unpredicted system inputs generating disproportionally strong dataflow which includes creation of the single communication channel that addresses the unpredicted system input. Conceptually, input signals indicative of a surprise scenario draw the NN's attention. Note that the NN may be designed such that errors are always accompanied by inputs: external errors (e.g., missing a target object because it moved) are noted by the same external sensors that have identified the object in the first place, and internal motor errors are noted by movement-inputs.

Optionally, the clusters of candidate channel clusters are arranged into a hierarchy. The highest level clusters may denote a target goal, for example, a robot arm moving an object to a target location. The middle level clusters may denote sub-targets of the goal, which implement smaller goals for reaching the target goal, for example, how to move the arm of the robot to move the object to the target goal, for example, grasp the object, swing arm up, rotate arm. The lowest level clusters may denote lower level instructions for achieving the sub-goals, for example, instructions for implementation by the motors of the arm and/or fingers. The order of lower level instructions may be determined according to the input, for example, according to sensors of the robotic arm that provide feedback on the current state of the motors, denoting the current position and/or rotation of the arm and the current position of the fingers (e.g., in grip state or open). Such hierarchical sequencing is in contrast to other approaches for controlling processor based systems, such as robot arms. For example, in standard programming approaches, a loop is used in which the next operation is simply started after the current one. In a standard neural network approach, lowest level operators would be selected one at a time, sequentially. In the NN described herein, the higher level clusters trigger all of the lower level operations that are needed to obtain the target goal and/or sub-goals. The order of triggering is based on the input, i.e., the real world state.

It is noted that several high level clusters may be executed in parallel, for example triggered by different input signals. In the robot arm example, the arm and fingers are simultaneously controlled to grasp the object and move the object, for example, when the input signals associated with the finger motors arrive simultaneously with the input signals associated with the arm motors. The candidate communication channels may be set up for the combination of the signals, and the selected single communication channel may denote the combined actions.

At 210, a single communication channel is selected from the multiple candidate communication channels. Alternatively, the single channel is created without multiple candidate communication channels being created, for example, when a single candidate communication channel is created, the single communication channel corresponds to the single candidate communication channel. The single channel may be directly created, for example, based on hard wired connections, fully learned connections, and/or a triggered urgent response (as described herein).

The single communication channel is selected by a competition process implemented by the inter-cluster neurons that exclude a sub-set of the candidate channel clusters included in the candidate communication channels, and select another sub-set of the candidate channel clusters included in the candidate communication channels. The competition process may be performed (e.g., iteratively, simultaneously) until a single communication channel is left from the multiple candidate communication channels.

A brief description of the competition process is now provided. To release dataflow, candidate channel neurons accumulate positive input values, resulting in an increasing value of the aggregated value described herein. This may occurs during each simulation timestep. Neurons do not necessarily release dataflow each timestep, for example, only after the aggregated value has increased above a threshold. Input from an inter-cluster neuron into a target candidate channel neuron resets the accumulated value of the target neuron. Dataflow from an inter-cluster neuron arriving when the aggregated value of the target candidate channel neuron is just below the threshold resets the aggregated value, and thus prevents the candidate channel neuron from outputting dataflow. In this case, the input from the inter-cluster neuron is inhibitory. However, dataflow from the inter-cluster neurons that arrives just after the target candidate channel neuron has released dataflow does not create an inhibitory effect (i.e., because the neuron's aggregated value is zero or very low. Moreover, when the dataflow from one inter-cluster neuron reaches several target candidate channel neurons, the dataflow simultaneously (or near simultaneously) resets the aggregated value of all of the target candidate channel neurons, so that they start accumulating aggregated values at the same time. As a result, when the candidate channel neurons accumulate aggregated values at approximately the same rate (e.g., when they have similar inputs), when they output dataflow, they output the dataflow simultaneously (or near simultaneously). In this case, the dataflow from the inter-cluster neuron(s) is a synchronizing dataflow. It is noted that this effect (inhibition or synchrony) may be done on all neuron types (i.e., candidate channel neurons, inter-cluster neurons, neurons of CT clusters, and neurons of Auxiliary clusters).

The set of candidate channel neurons and/or clusters involved in implementing a single specific response are sometimes referred to as a quax (plural quacia). That is, a quax indicates a computed input-response mapping. The role of competition is to determine which candidate channel neurons (and thus clusters) get included in a quax (i.e. a ‘win’ of the competition). Alerts may trigger DM network flow that represents the previously learned responses to features of the input signals. This means that there are many clusters triggered in DM mode (i.e., their input, alert and DM networks are triggered). These clusters denote a quax candidate pool. Candidates compete such that only a small subset of them wins. When a cluster wins, it switches to execution mode (i.e., its focus and/or response networks are triggered). It may also switch to stable DM mode (i.e., its DM network is triggered after competition). Losing clusters are suppressed (i.e., prevented from triggering dataflow output).

The competition process may be mediated by the inter-cluster neurons (e.g., inhibitory neurons that suppress their target neurons from triggering further dataflow output, belonging to coordination networks), optionally using a process termed Join or Stop (JOS). For example, for an coordination inter-cluster neuron C that excites a neuron M, when the main effect of C on M's aggregation value is just before M would trigger output of dataflow, C prevents this triggering (e.g., by reducing the value of the aggregated value at the input). Conversely, when the main effect of C on M is just after M triggers output of dataflow, C does not have a negative effect on triggering, because after a neuron outputs dataflow, the neuron returns to the non-triggering state, e.g., the aggregated value is reset. Moreover, when C triggers two neurons and affects them just after they trigger output of dataflow, and when the two neurons receive charge from the same source, its effect is not inhibitory but rather to synchronize their triggering (i.e., because the aggregation values are resets at the same time, and new values are aggregated at the same rate). Thus, the effect of an inter-cluster neuron is JOS: it either makes its target neuron stop being triggered and outputting dataflow, or it makes them join the coordinated activation of other neurons. It is noted that the JOS mechanism may synchronize both candidate channel neurons and other inter-cluster neurons.

When a content neuron triggers an inter-cluster neuron, a coordination request is issued. This way, the coordination networks are activated when dataflow reaches content clusters, and their activation imposes the JOS operator on their targets (both content and coordination neurons). The suppressive inter-cluster neurons suppress input connections to the response network (and other networks). The disinhibition inter-cluster neurons suppress the suppressive inter-cluster neurons, which means that they disinhibit (i.e., allow) response network inputs. The BLK blanket inter-cluster neurons may suppress everything around them.

The described architecture allows strong dataflow to create a disinhibited ‘hole’ that activates the response network, which is surrounded by a ‘blanket’ of suppression. This is the goal of the competition process in selecting the single communication channel.

The competition process ends when local content candidate channel neurons are either triggered synchronously or are silent. Because this occurs in all clusters to which dataflow arrives, a winning group (e.g., the quax, the candidate communication channels) emerges that includes both primary input clusters and primary response clusters.

Competition is held between different clusters. It may be held between their response neurons or between their DM neurons, or between their focus neurons. The latter two alternatives are valid, because the quax may include clusters active in focus or DM mode, as explained herein with reference to predictions.

The process for selecting the single channel from the multiple candidate communication channels may be assisted by CT dataflow from CT clusters in the following exemplary process. Activated response candidate channel neurons excite neurons whose outputs are of a CT dataflow type (e.g., DEC) that has two associated connection markings, DEC1 and DEC2. DEC1 is of low affinity and triggers neurons, while DEC2 is of high affinity and suppresses neurons. The connectivity of DEC-output neurons is such that they target the vicinity of the candidate channel neurons driving them (i.e., closing a loop). Surprises involve bursts that activate many response candidate channel neurons, yielding high DEC and the activation of DEC1 markings. Conversely, predicted transitions yield the release of small amounts of DEC, activating DEC2 markings.

Competition is facilitated by DEC by having DEC1 markings on the neurons located in dataflow paths in which competition occurs. For example, this may include some of the paths in the AUX2 cluster(s), the paths that lead to neurons that lead to AUX1 cluster(s) that should be disinhibited. Competition may be facilitated by DEC2 markings. For example, DEC2 markings on AUX2 paths that support automated (non-competing) actions would suppress automated ongoing actions to allow competitions. A similar effect can be achieved by DEC2 markings located on response neurons.

DEC2 markings on response candidate channel neurons also facilitate the suppression of completed actions. When a predicted action goal has been attained, the neurons representing it switch to response mode, thereby triggering a small number of DEC-releasing neurons, which release a small amount of DEC. This DEC reaches back to the response candidate channel neurons, activating its high affinity DEC2 markings and suppressing it.

A useful technique is to implement the NN such that the effect of DEC1 activation sustains the neuron's activity for a relatively long time. In this case, DEC1 also sustains task execution after facilitating competition. Combining these two properties, the DEC CT dataflow types makes decisions.

Finer control over decisions may be achieved by using more than a single CT dataflow type. For example, the DEC CT dataflow type described above may be used for decisions that involve flow generated by needs (internal needs and external threats and opportunities), while a different CT dataflow type (e.g., EXE) may be used for executing decisions that involve flow generated by lower-level input events (small surprises occurring during execution, which change how a response is executed but not the whole task). EXE-releasing neurons may be excited by the response network and suppressed by AUX2. EXE could support competition via fast acting and fast diminishing markings that excite the disinhibitory CRUs in the CCN and the response network candidate channel neurons, and via markings that take longer to diminish that sustain the activation of response network candidate channel neurons and ECN CRUS and suppress the blanker neurons of the CCN to remove their blanket suppression in focused quax connections.

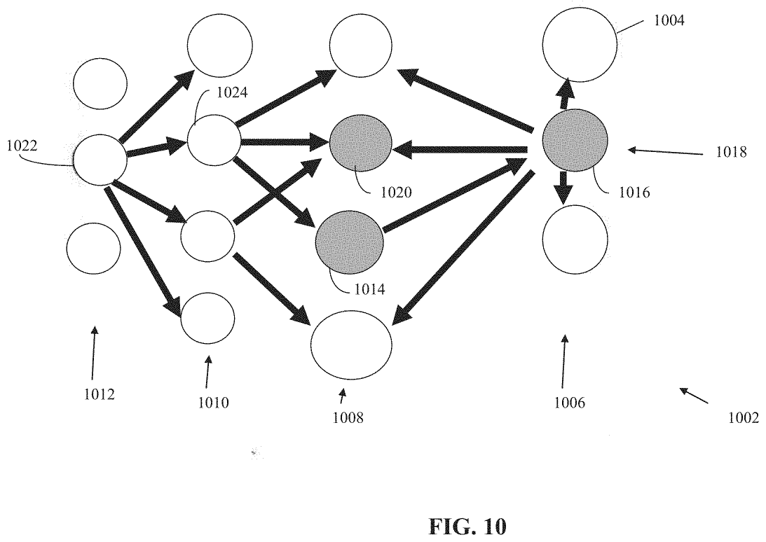

Reference is now made to FIG. 10, which is a schematic depicting the competition process for selecting a single communication channel from multiple candidate communication channels, in accordance with some embodiments of the present invention. An exemplary architecture of NN 1002 is depicted. Circles (e.g., one circle 1004 depicted for clarity) denote clusters of candidate channel neurons. NN 1002 includes input region 1006 with three candidate channel clusters, and three response regions: 1008 denoting a low level response region with 4 clusters, 1010 denoting a medium level response region with 4 clusters, and 1012 denoting a high level response region with 3 clusters. Region 1012 represents high level goals (e.g., “get to a given destination” in the automated vehicle example). 1010 represents action plans (operation sequences) executed to satisfy the high level goal. 1008 represents individual operations (steer left/right, gas, brake). An action plan node 1014 triggers a certain operation, which is executing. The goal may be represented by sensory cluster 1016, which denotes a sensory event. When the input 1018 triggers 1016, the goal of the operation of cluster 1014 has been attained. The triggering of 1016 triggers dataflow in the forward. The forward dataflow triggers many clusters, but the one that actually activates is cluster 1020, because it receives both forward direction dataflow from 1016 and non-forward dataflow flow from the executing clusters of 1010. Cluster 1020 triggers low level operations in region 1008 like cluster 1014 did before it. In summary, FIG. 10 depicts how action sequences are generated from cluster region to cluster region dataflow and selection done by the input.

FIG. 10 depicts the process of execution towards achieving a target goal. Prior to the time depicted in FIG. 10, there was input, forward and non-forward dataflow, setting up of multiple candidate communication channels, and a competition process, that resulted in the selection of cluster 1022 (the middle one) and a target goal (not shown—such goal may denote an event, e.g., the vehicle reaching a target destination, represented by a certain cluster combination). The forward and non-forward dataflows may be represented by arrows in a forward and non-forward direction between clusters of 1006, 1008, 1010, and 1012. The multiple candidate communication channels may be represented as multiple paths within the clusters of 1006, 1008, 1010, and 1012 based on the forward and non-forward dataflows. After the selection of the cluster 1022 and the associated target goal, there were several possible action plans (i.e., action sequences) to attain the target goal (i.e., the clusters region 1010 which triggered by 1022). From the clusters of 1010, cluster 1024 was selected. An action plan includes a sequence of lower level operators (i.e., denotes by clusters of region 1008).

The next operator in the sequence (i.e., the order of low level actions) is determined by the input. This process is different than programming an action sequence in an ordinary software program. In a standard programming approach, a loop is used in which the next operation is simply started after the current one has been completed. In a standard NN, this translates to the action plan cluster in determining its lower level operators one by one. However, in NN 1002 described herein, sequencing does not happen this way. Rather, the action plan cluster triggers all of the lower level operations that are relevant to the target goal, and their order is determined by the external environment (the input), i.e., by what is currently possible.

It is noted that it is certainly possible that several of the operators of region 1012 would execute in parallel, if they are triggered by different inputs. For example, for a processor based system implemented as a robot moving its arm to grasp an object in order to put it in a target location, the highest level task denoted by 1012 has a goal of “object should be in target location”. This is an external event. An action plan in region 1010 executes a series of individual limb movement operators (region 1008) to attain the task. The movement operators consist of both moving the arm, and moving its fingers to grasp the objects. The robot may move its arm and its fingers at the same time, e.g., if the inputs that trigger finger movement arrive while it is moving its arms. For example, the inputs that trigger finger motion can be “move finger when you are quite close to the object”. This description is what humans and animals do to grasp something, by learning to contract several muscles simultaneously.

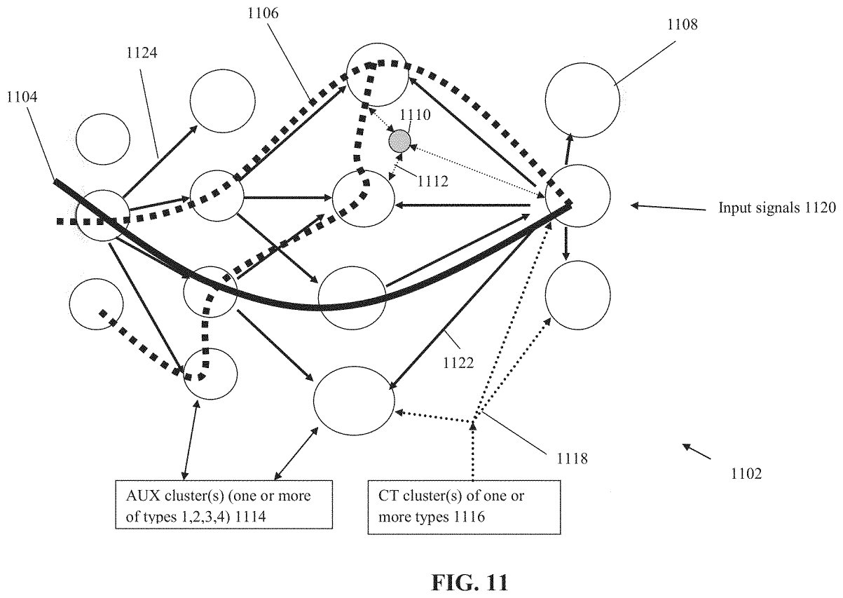

Reference is now made to FIG. 11, which is a schematic of a NN 1102 in which a single communication channel 1104 (shown as thick solid curved line) is selected from multiple communication channels 1106 (shown as thick dashed curved lines), in accordance with some embodiments of the present invention. NN 1102 is as described herein, including multiple candidate channel clusters of candidate channel neurons (show as circles, one cluster 1108 is marked for clarity), connected by inter-cluster neurons (and/or clusters thereof), shown as filled in circles, one cluster 1110 is shown for simplicity and clarity, and one inter-cluster connection (shown by dashed arrows) is marked 1112, although it is to be understood that there are multiple such inter-cluster neurons (and/or clusters thereof) connecting between different neurons and/or clusters. Optionally, one or more auxiliary clusters 1114 of one or more types 1, 2, 3, and/or 4 are included. Optionally, one or more CT clusters 1116 of different CT types are included. The CT clusters 1116 generate diffuse CT dataflow of respective types, depicted by dashed arrows 1118 that diffuse out of a single cluster to trigger multiple candidate channel cluster neurons.

As described herein, input signals 1120 trigger a forward dataflow, depicted by arrows generally pointing from right to left (one arrow 1122 shown for clarity), and a non-forward dataflow, depicted by arrows generally pointing from left to right (one arrow 1124 shown for clarity). Candidate communication channels 1106 are established based on a competition process mediated by inter-cluster neurons 1110, as described herein, for selection of single communication channel 1104.

Referring now back to FIG. 2, at 212, the process for selection (e.g., competition process) of the single communication channel triggers creation of one or more candidate predictive communication channel for implementing a next action after the single communication channel is selected. The predictive channel is more likely to be selected by the expected additional input, optionally by setting up the single channel without necessarily setting up multiple candidate channels first, which may reduce processing resources and/or processing time for executing the predicting response. Additional input signals, which arrive after the current input signals, trigger a selection of the next action by selecting a single predictive communication channel from another set of candidate communication channels created in response to the new input signals (as described herein for the current input signals). The new set of candidate communication channels include the candidate predictive communication channel which was established by the previous single communication channel.

Execution involves the coordinated activity of response and focus networks neurons (i.e., of clusters active in response or focus mode). The two networks have different but complementary roles in response execution. The response network represents the actions that are currently being executed and the object configurations perceived by the NN as occurring in present time (in reality). The focus network represents actions that are prepared or predicted to be executed in the near future, and object configurations predicted to occur as a result of the executing actions. Thus, these object configurations can be viewed as representing both the goals of the executing actions, and the conditions under which execution should stop. For example, consider NN input signals generated by a physical object, and a response that moves a robotic arm to touch the object (e.g., to grasp it in order to move it somewhere). The clusters representing the movement (i.e., the clusters directly and indirectly driving the motors) are active in response mode, which includes focus and response candidate response neurons. The response candidate response neurons drive the motors, while the focus candidate response neurons excite focus network candidate response neurons in nodes that represent the goal of the movement. Here, the goal is to have the robotic arm touch the object, a configuration represented by a collections of clusters, some receiving relevant input (touch sensitive input), some indicating the state of the robotic arm, and the like.

Triggering creation of one or more candidate predictive communication channel may be advantageous for two main reasons. First, assisting the transition to the next action and/or saving energy, as described herein. Second, allowing the NN to monitor its actions in order to detect execution errors. Predictions are activations of focus network candidate channel neurons. Since the focus network excites the response network, response candidate channel neurons in predicted clusters are partially triggered during execution (i.e., they receive dataflow, but the aggregated value is still below the trigger threshold). To detect errors, the system may use the notion of burst, as described herein.

At 214, a single response mapped to the input signals by the single communication channel is outputted by the NN.

The execution of the selected responses involves neuron triggering (termed predictions), which use the focus (or DM) network.

At 216, the processor based system implements the outputted single response. The single response may denote instructions for control of the processor based system. For example, when the processor based system is an automated (or semi-automated) vehicle, and the input signal denotes an impending collision (e.g., image of an object in the path of the vehicle), the outputted single response denotes a navigation maneuver by the vehicle (e.g., swerve left, swerve right, brake). The vehicle implements the single response, for example, by serving left, swerving right, or braking.

At 218, a transition may be implemented in response to execution of the response. When the execution of the response completes, the next response is selected via transitions.

An action completes when its goals have been attained. In the NN described herein, this happens when the clusters representing the action's goals are activated in response mode (e.g., when their activation switches from focus mode to response mode). Since most useful tasks involve action sequences rather than single isolated actions, the attainment of an action's goals should trigger the execution of the next action in the sequence. This is termed herein, a transition. Transitions may be pre-programmed into the NN by clusters that drive sequences of pre-determined actions. When the goals of one action have been attained, they excite the clusters to switch to the next action. A novel, more flexible method to implement transitions is as follows. When a clusters is activated in response mode to execute a response, its response candidate channel neurons are activated. Each such response candidate channel neuron triggers all of its neuron targets. Assuming that inter-neuron connections exist because they are potentially useful (e.g., they have served a similar response in the past, as described with reference to training the NN), then an executing response partially triggers all of the candidate channel clusters that may be relevant to implement the next action. The term mobilization is used herein to refer to this kind of triggering. When a goal is attained, new input arrives, switching its representing clusters to response mode. The input signals also trigger dataflow in the input, alert and DM networks. When this dataflow meets candidate channel clusters that have been mobilized and/or predicted, the combined input and mobilization dataflow may activate them in response mode, which may set-up the next single communication channel and/or selects the single communication channel from the candidate communication channels. In other words, aided by mobilization and predictions, the input selects the next action in the sequence by setting up the single communication channel, and/or selecting the single communication channel from the candidate communication channels.

When an executing action whose goals have been attained needs to be stopped, this may be automatically achieved by competition between itself and the next action in the sequence. The correct next action should win the competition, because it is supported by the current input.

A 220, the NN is updated with the single channel mapping input to output. Future feedings of the input channel may set-up the single channel to map to the output, without first setting up multiple candidate channels that are resolved to select the single channel, which may reduce the time for obtaining the output in response to the input.

Optionally, a learning process is triggered by the formation of the single communication channel. The learning process triggers changes in the NN for increasing likelihood of future inclusion of the selected single communication channel in a future set of candidate communication channels created in response to a future input signal corresponding to the input signal. Alternatively or additionally, the learning process triggers changes in the NN for reducing likelihood of non-selected candidate communication channels being included in the future set of candidate communication channels. The changes may be, for example, architectural changes such as addition of neurons, removal of neurons, new connections between neurons, and removal of connections between neurons. The changes may be, for example, changes in values of existing NN parameters, for example, thresholds of connections that affect whether the incoming dataflow triggers output dataflow or not.

It is noted that the user may be provided with an option to correct learning mistakes by the NN, for example, to designate a provided output as incorrect, which may trigger the NN to recompute another output. The user may use, for example, a GUI and/or other interface to mark outputs as incorrect.

Learning may occur by the NN receiving input, generating output, and learning, as described with reference to acts 218. Such learning may be used to updated and/or fine tune a trained neural network. Such learning may optimize and/or speed up the processing speed of the NN. Alternatively or additionally, learning may occur by providing the NN with input and output, as described below with reference to FIG. 3. Optionally, initially, the NN is trained according to the method of FIG. 3, and optionally updated in response to the inference process of FIG. 2, as described with reference to act 218.

Referring now to FIG. 3, the goal of learning by the NN (also referred herein as training the NN) is to facilitate the future activation of candidate channel clusters (also referred to herein as quacia) that had been successfully executed.

At 302, a training dataset for training the NN is created and/or provided. The training dataset includes sets of training inputs and corresponding training outputs. The training inputs and training outputs may be designed to correspond to the expected inputs and generated outputs of the target processor based system, for example, inputs expected to be received based on output of sensors of the processor based system, and outputs for being received by the processor based system, such as by code, and/or electro-mechanical components with moving parts.

There may be two types of responses that the NN can provide. The first type (termed herein Type 1 task) exist in the NN-external world relationship and the NN needs to identify them. The second type (termed herein Type2 tasks) and responses that involve NN-external changes caused by the NN itself. An example of a Type1 task is the task of naming a person given their face. Both the face and the name exist in the world, and the NN's task is to associate them. An example of Type2 tasks are movements of robotic arms driven by the NN to achieve a certain goal, e.g., to grasp an object and put it somewhere. Another example of a Type2 task is the display of a desired textual (or other) response on a computer screen. Type 2 tasks cannot be performed by standard NN.

It is noted that unlike standard neural networks that are trained using input data labeled with a target classification category, the NN described herein is trained using target input and corresponding output which may be instructions for execution by a processor, and/or signals that trigger a desired outcome of the processor based system. For example, the output may be a set of instructions (e.g., code, signals) for maneuvering a robot arm.

At 304, the target input and corresponding target output of the training dataset are fed into the NN.

Optionally, the target input and target output are fed into the NN by training code. In this manner, the NN learns by self discovery the correct output, by learning what it executes. However, such training may be too slow and/or risky, for example, when errors cannot be tolerated such as a robot arm mishandling breakable objects, as described herein. Alternatively, the target output may be explicitly fed into the NN by setting up the processor based system into a state depicting the target output. For example, when the processor based system includes an electro-mechanical component with moving parts, the moving parts may be placed in a position indicative of the target output. The position may be set by a human operator and/or automatic code that guides the moving parts. For example, the human operator may manually maneuver the robot arm into a static position indicating the target output, or the maneuver itself provides a dynamic type of target output. In another example, the human operator drives the automatic vehicle, thereby providing target outputs in the form of desired navigation maneuvers in response to target input such as an image of an oncoming vehicle or pedestrian. In another example, when the processor based system is without moving parts, the human may manually use the computer (e.g., application, GUI, code) to provide the target output. It is noted that the process of providing target output by a human manually operating the moving part component and/or manually using a computer has no counterpart in standard NN training.

As used herein, the term target output and target response are interchangeable.

With reference to the two types of tasks, the NN is trained by feeding it with inputs that prime it towards the desired response. The two types differ in how such feeding is done. For Type1 tasks, the NN-external entities that need to be associated are given as inputs, simultaneously. Note that in order to be able to deal with an external entity in any way, the NN is capable of receiving inputs originating in that entity. In the example above, the NN is fed with visual inputs representing the person's face and with textual or auditory inputs representing the person's name. These two inputs yield flow in the input network in primary input clusters and then in other networks and other clusters, as described herein. At some point, the two flows meet and a quax (i.e., a single communication channel) is established. This is an associative quax. Naturally, an associative quax can associate several types of inputs, not just two. After training (with any number of training examples), when the NN needs to perform the task (i.e., in test time), it is given only one of the inputs (e.g., the visual one), and a quax will form that reaches the associated name cluster. Getting the name as an output of the NN may be done in two exemplary ways. First, the NN's name clusters (i.e., clusters representing names) may be examined, and take the name cluster whose response network is triggered. This is the usual approach. Note that it is easy to discover which clusters are name clusters (or clusters representing any specific data type), via their trigger patterns when the NN is exposed to names. Second, the NN may be trained to output the triggered name (or any word) using a Type2 task. In Type2 tasks, the NN produces its response by making changes to the external world. Here too, it can be trained to make these changes by priming the NN clusters whose response networks are capable of producing the desired changes. For example, if the response should be provided by movement of a robotic arm, the arm may be moved by an external tutor as part of the training process. Since arm movements generate inputs (of the movement-input type), movements caused by the tutor generate system inputs that are similar to those generated when the desired movements are produced. Moreover, if the NN has additional sensors that monitor its own movements (e.g., visual ones), these also generate inputs that accord with the desired movement. These inputs prime the NN such that when it is required to produce movements in response to given inputs (e.g., the object to be moved), the neurons that produce the desired movements are primed due to the associative training, which allows the desired nodes to win the competition and join the emerging execution quax.

It is noted that it is not necessary to teach the NN to produce world changes for every specific task. It is only necessary to teach it to produce all of the types of changes that it should produce as responses. For example, once it is taught to grasp an object, it can grasp any object, not just a specific object. If the task is to select a particular object and grasp it, object selection results from training in an object selection task, which is a Type1 task, while grasping it results from training in the general object grasping task, which is a Type2 task. In other words, training the NN to use its output devices in order to communicate with the external world (which is the essence of Type2 tasks) is independent from training it how to select the content of this communication. This system property is especially salient in executive systems, since by the nature of connectivity of the executive area, it naturally learns to participate in the execution of abstract and/or longer term tasks.

This kind of training is automatically multidirectional (bidirectional in this example), because it teaches a symmetric association. As a result, it can provide the inputs to the NN in any order, including simultaneously.

At 306, forward and non-forward dataflows are triggered, for example, as described with reference to act 206 of FIG. 2.

Optionally, the target input triggers dataflow in a forward direction, and the target output triggers dataflow in a non-forward direction. The target input may also trigger dataflow in the non-forward direction. The flow in the non-forward direction is performed before the flow in the forward direction and/or simultaneously with the flow in the forward direction. Such non-forward dataflow before and/or simultaneously with forward dataflow is in contrast to training of standard NN based on non-forward propagation, in which the non-forward propagation occurs only after forward flow has completed and created an output.

At 308, multiple candidate communication channels mapping target input to target output may be created, for example, as described with reference to act 208 of FIG. 2. The multiple candidate communication channels denote different paths that map the target input to target output. Alternatively, a single candidate communication channel is created.

At 310, a single communication channel is selected from the multiple candidate communication channels, for example, as described with reference to act 210 of FIG. 2.

At 312, adaptations to the NN are triggered in response to the single communication channel (which is selected or is directly created).

At some time point after the formation and/or selection of the single communication channel (i.e., a quax, an input-response mapping potentially containing many neurons and connections), learning processes are started. This time point may be, for example, while the NN executes, when the NN stops executing, when the task stops executing, when the NN does not need to deal with inputs, and/or at certain pre-scheduled times or time intervals. It is possible to evoke different specific learning processes in different time points. For example, learning may be triggered during act 220 of FIG. 2 in association with an inference stage, and/or as a dedicated learning state of FIG. 3, and/or other options.

The adaptations to the NN are for increasing likelihood of future inclusion of the selected single communication channel in a future set of candidate communication channels created in response to a future input signal corresponding to the target input signal. Alternatively or additionally, the adaptations to the NN are for reducing likelihood of non-selected candidate communication channels being included in the future set of candidate communication channels.

Optionally exemplary adaptations include architectural changes such as addition of neurons, removal of neurons, new connections between neurons, and removal of connections between neurons.

Alternatively or additionally, exemplary adaptations include changes in values of existing NN parameters, for example, thresholds of connections that affect whether the incoming dataflow triggers output dataflow or not, modifying dataflow capacity of existing neuron connections, modifying energy utilization, and modifying system protection parameters.

Expressed in another manner, there are several types of exemplary learning processes. Capacity processes modify the capacity of existing connections. Structural (connectivity) processes create or remove neurons and/or connections. Optimization processes modify energy utilization and/or system protection parameters. The changes that learning processes induce are determined, for example, by the frequency of activation of connections and/or by the participation of CT clusters in executing candidate channel clusters.

Optionally, the type and/or magnitude of the adaptations to the NN are determined, for example, by frequency of dataflow over connections of candidate channel neurons of the candidate channel clusters included in the single communication channel, and/or determined according to the dataflow CTs included in the single communication channel.

Optionally, the forward dataflow and non-forward dataflow propagated by outputs of activated candidate channel clusters trigger low affinity CT indications in vicinity of the respective output site and trigger high affinity CT indications farther away from the respective output site. Such triggering is based on the diffuse nature of triggering by the CT clusters, as described herein. A process termed herein a double edged agent principle (DEAP) may be triggered. In DEAP, a single CT cluster may induce both the grow process (312A) and the shrink process (312B), depending on the amount and rate of its effect on neurons and connections. High or low amounts and/or rates of dataflow outputted by the CT clusters (e.g., due to high or low frequency activation of the neurons outputting the dataflow) induce grow or shrink, respectively. In this case, the site of dataflow output by the CT clusters (e.g., near neurons of the selected single communication channel) undergo growth, and farther locations induce shrink.

Optionally, high frequency dataflow triggers a growth process (e.g., act 312A) for increasing likelihood of future inclusion of respective candidate channel clusters in a future selected single communication channel. Low frequency dataflow triggers a shrink process (e.g., act 312B) for decreasing likelihood of future inclusion of respective candidate channel clusters in the future selected single communication channel. The site of dataflow output near neurons of the single communication channel undergo the growth process (e.g., act 312A) and farther neurons undergo the shrink process (e.g., act 312B).

The described scenario achieves the desired effect of strengthening (i.e., increasing likelihood of being included in future candidate communication channels) of the candidate channel clusters that were executed (i.e., competition winners) while weakening (i.e., reducing likelihood of being included in future candidate communication channels) candidate channel clusters that the NN has chosen not to execute (i.e., competition losers, excluded from the single communication channel).

There may be two types of learning situations, reflecting the two types of adaptive process responses, termed acute and automated. The learning processes induced by these types are different.

Optionally, an acute learning response is triggered. The acute learning response includes high frequency dataflow over the single communication channel, and/or activation of certain CT indications facilitating certain dataflow CT of the single communication channel, and/or activation of the certain CT indications of non-selected candidate communication channels. Expressed in another way, acute responses involve high frequency activation of winning connections, and the activation of CT markings facilitating decisions, located on both winning and losing connections.

The acute learning response increases likelihood of neurons of the single communication channel being included in a future selected single communication channel, also referred to herein as yielding augmentation. The augmentation facilitates future triggering of executed acute quacia by increasing their chances of winning future competitions. This involves two operators, grow (act 312A) and shrink (act 312B).

At 312A, a growth adaptation component of the process of adaptation of the NN is triggered. The grow process may include one or more of: increasing capacity of connections between neurons of the single communication channel, increasing branching and extent of the connections, creating new neurons and connections thereof, and increasing energy consumption.

The grow process may be triggered by high frequency dataflow of a certain CT. Grow may be induced by high frequency triggering, and/or by RC markings (as described herein).

Growth increases the capacity of connections supporting competition winners, increases the branching and extent of these connections, creates new neurons and connections, and increases energy consumption.

Alternatively or additionally, at 312B, a shrink adaptation component of the process of adaptation of the NN is triggered. The shrink process may include one or more of: decreasing capacity of connections of neurons excluded from the single communication channel, decreasing branching and extent thereof, removing superfluous connections and neurons, and decreasing energy consumption.

The shrink process may be triggered by low frequency dataflow of a certain CT. Shrink may be induced by low frequency triggering, and/or by RC markings. Shrink decreases the capacity of the connections supporting competition losers, decreases their branching and extent, removes superfluous connections and neurons, and decreases energy consumption.

Conceptually, there is a learning Grow or Shrink (GOS) process, which conceptually mirrors the JOS competition operator. Competition winners (losers) naturally activate at high (low) frequency, which automatically determines whether they would undergo grow or shrink (with the possible involvement of RCTs).

Grow and shrink process may increase and decrease the structural strength and/or capacity of the connection such that when stability and/or capacity fall below a certain threshold, the connection is removed. Similarly, grow and/or shrink may increase and/or decrease the branching, length and extent (wide or narrow node reach) of neuron outputs and/or inputs according to the amount and/or rate of dataflow outputted by CT clusters that affect them. Output connections that participate in a quax bifurcate and increase their extent in the direction of input connections participating in the same quax. This results in a faster activation of the quax (the input-output mapping) the next time that the conditions call for it (in other words, it increases automaticity).

Grow may induce new neurons when the amount of acute (alert and DM) dataflow reaching a designated area of neurons exceeds a certain threshold. When such neurogenesis occurs, the new neuron is typically connected to a small fraction of the neurons in the area, those participating in the quax that had induced neurogenesis. Neurogenesis may be limited to occur in a specific area in a hard-coded manner, and/or be allowed to occur all over the NN. Neurogenesis increases the sensitivity of the NN to specific input conditions, by increasing number of possible quacia. Shrink may induce the removal of neurons by removing a sufficiently large number of its inputs.

There are various possible mathematical relationships between dataflow outputted by CT clusters and the capacity and connectivity changes that it affects. For example, capacity growth or shrink can be related to the changes that had yielded neuron activation, for example, by a linear, polynomial or an exponential equation. In general, the higher the rate of change, the faster the NN learns.

Alternatively, automated responses involve very little competition, single neuron activations or low frequency ones, and high affinity markings. As a result, they do not yield augmentation. Instead, they yield shrink, whose effects are as described above, and optimization, which facilitates their future activations in various ways, for example by reduced energy requirements.

It is noted that low frequency activations yield shrink, but single activations do not necessarily yield shrink. Otherwise, connections participating in automated quacia (responses) would be damaged. This way, automated responses have reduced aggregated value (triggering) requirements. Automaticity results in a one-pass selection of input-response mappings without needing competition. This can happen because the learning induced after acute responses increases synchronization.

An example for reduced energy by automaticity is to have the shrink operator reduce the utilization of energy resources that drive motors. This should not harm execution, because automated responses have very accurate predictions, which greatly facilitate execution. Thus, energy requirements can be safely reduced after good predictions are learned.

Another exemplary learning process is to increase the activation speed of a neuron when it participates in an executed quax (i.e., the selected single communication channel). This can be easily done, for example, by reducing the neuron's trigger threshold. Using this technique, neurons that were used in the past learn to output dataflow to their target neurons faster, thereby increasing the probability that they win competitions and increasing synchronized activation. This technique is especially useful for inter-cluster neurons, particularly those in the ECN, because it allows them to coordinate execution faster. The magnitude of speed increase may be a function, for example, of the acuteness of the response, such that the amount of automaticity of a response is inversely related to the amount of speed modification.

At 314, acts 304-312 (e.g., including 312A-B) are iterated for different target input and corresponding target output of the training dataset.

At 316, the trained NN is provided for inference, as described with reference to FIG. 2.

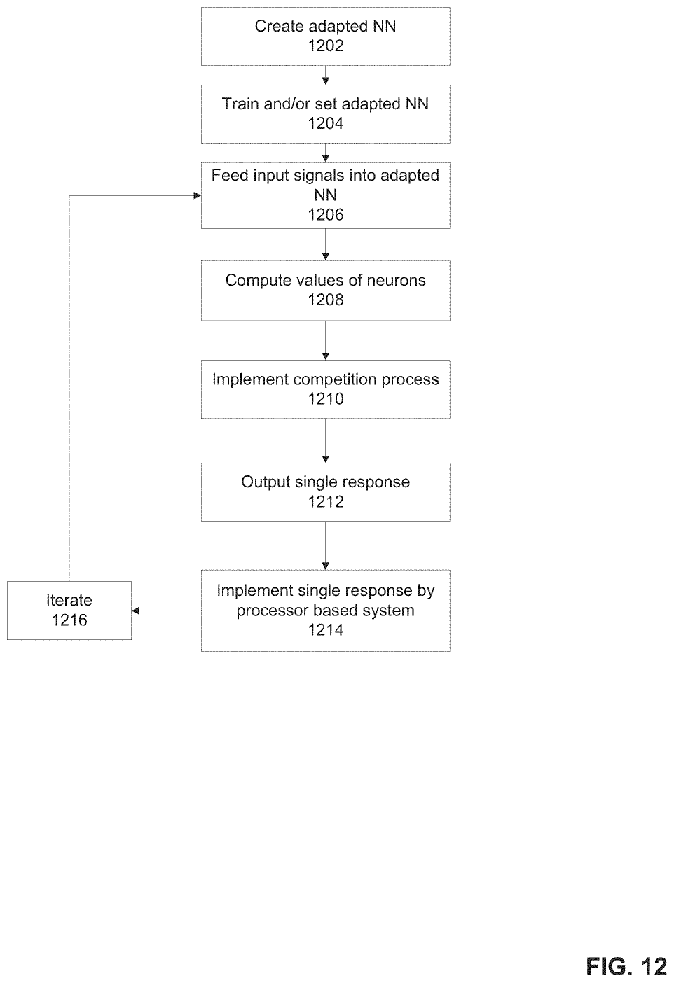

Reference is now made to FIG. 12, which is a flowchart of a method for executing an inference process using an adaptive NN that includes a standard NN and inter-cluster neurons that connect between neurons of the standard NN, in accordance with some embodiments of the present invention. The adaptive NN described with reference to FIG. 12 may be trained and/or implemented using components of system 100 described with reference to FIG. 1. Features of the NN described herein with respect to FIGS. 2-11 may be integrated with, and/or combined with, and/or substituted with, and/or serve as a basis for, features of the adaptive NN described with reference to FIG. 12.

At 1202, an adaptive NN is created. The adaptive NN may be created from a standard NN (e.g., DNN, CNN, RNN, other architectures and/or combinations thereof) may be created by integrating the inter-cluster neurons (e.g., as described herein) with the standard NN, by connecting the inter-cluster neurons between neurons of the standard neural network. The inter-cluster neurons execute the competition process, as described herein.

At 1204, the adaptive NN may be trained and/or set. The threshold used to select neurons or exclude neurons from generating the output of the adaptive NN may be predefined and/or learned according to a training dataset.

The threshold may be defined according to a signal-to-noise value, for example, computed based on signals inputted into the adapted NN. For example, high variability in signal input of the training dataset may lead to a low (or high) threshold value. Low variability in signal input of the training dataset may lead to a high (or low) threshold value. The threshold may be selected to stabilize the output of the adapted NN when variability in input signals are provided. For example, a standard NN's output may vary (e.g., continuously) for variability in signal input, while the adaptive NN's output may be stable even for variability in signal input.

At 1206, input signals are fed into the adapted neural network. The signals may be outputted from sensors monitoring the processor based system, as described herein.

At 1208, values of neurons of the adaptive NN may be computed, for example, weights are computed based on standard NN processes according to the input. The values of neurons of the adaptive NN may be computed by forward (optionally only forward) dataflow from input to output, based on the design of the standard NN.

At 1210, the competition process is implemented by the inter-cluster neurons. The inter-cluster neurons select a sub-set of neurons for generating the output, and exclude another sub-set of neurons from generating the output. For example, neurons having values above (or below) the threshold are included, and/or neurons having values below (or above) the threshold are excluded.

Optionally, the selected neurons are synchronized (e.g., temporarily), and/or the excluded neurons are suppressed, for example, as described herein.

Conceptually, the competition process is based on a binary selection or exclusion of to neurons for generating the output, in contrast to standard NN where neurons have continuous values with the highest values participating in the output.

At 1212, a single response is outputted. The output is mapped to the input signals by the selected sub-set of neurons. The single response may denote instructions for control of the processor based system.

At 1214, the single response is implemented by the process based system, for example, as described herein.

At 1216, features described with reference to 1206-1214 are iterated, for example, for newly received input signals.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant neurons and processor based systems will be developed and the scope of the terms neurons and processor based systems are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

What is claimed is:

1-49. (canceled)

50. A neural network comprising:
a plurality of neuron clusters, wherein each cluster comprises at least one neuron; and
at least one inter-cluster neuron, wherein each of said at least one inter-cluster neurons connects among at least two of said neuron clusters,
wherein said neural network is configured to receive a plurality of input signals and propagate said input signals in a forward direction between an input of said neural network and an output of said neural network, and in a non-forward direction between said output and said input, and
wherein said at least one inter-cluster neuron is configured to implement a competition process which selects a dataflow path between said input and said output, said dataflow path comprising a specified subset of said neuron clusters, based, at least in part, on selectively modifying a value of at least some of said connected neuron clusters in response to said plurality of input signals.

51. The neural network of claim 50, wherein said inter-cluster neurons have an activation speed that is faster than an activation speed of said neurons.

52. The neural network of claim 50, wherein said modifying comprises providing an input to said at least some of said connected neuron clusters which resets said value.

53. The neural network of claim 52, wherein said resetting results in a synchronized activation of said at least some of said connected neuron clusters with respect to said dataflow path.

54. The neural network of claim 52, wherein, when said resetting with respect to a specified neuron cluster occurs before an activation of said specified neuron cluster, said resetting results in inhibiting said specified neuron cluster.

55. The neural network of claim 54, wherein said inhibiting excludes said specified neuron cluster from said dataflow path.

56. The neural network of claim 50, wherein at least some of said neuron clusters are neural network layers.

57. The neural network of claim 50, wherein said non-forward direction comprises one or more of: propagating said input signals from said output to said input; propagating said input signals within one of said neuron clusters; propagating said input signals in a vertical direction; propagating said input signals between any pair of connected said neuron clusters.

58. The neural network of claim 50, wherein said non-forward direction comprises propagating said input signals into selected ones of said neuron clusters comprising said output, wherein said selected ones of said neuron clusters represent a correct output by said neural network with respect to said input signals.

59. The neural network of claim 50, wherein the neural network is hard-wired or trained to implement a specified said dataflow path with respect to specified said input signals.

60. The neural network of claim 50, further comprising at least one of: one or more connection-type neurons configured for modulating the effect of said input signals on said neuron clusters, and one or more auxiliary neuron clusters configured for providing a feedback loop which sustains activation of at least some of said neuron clusters.

61. A method comprising:
providing a neural network comprising:
a plurality of neuron clusters, wherein each neuron cluster comprises at least one neuron; and
at least one inter-cluster neuron, wherein each of said at least one inter-cluster neurons connects among at least two of said neuron clusters,
wherein said neural network is configured to receive a plurality of input signals and propagate said input signals in a forward direction between an input of said neural network and an output of said neural network, and in a non-forward direction between said output and said input, and
wherein said at least one inter-cluster neuron is configured to implement a competition process which selects a dataflow path between said input and said output, said dataflow path comprising a specified subset of said neuron clusters, based, at least in part, on selectively modifying a value of at least some of said connected neuron clusters in response to said plurality of input signals;
receiving into said neural network a plurality of input signals, wherein said receiving causes a propagation of said input signals in a forward direction between said input and said output, and in a non-forward direction between said output and said input; and
implementing, by said at least one inter-cluster neuron, said competition process to select said a dataflow path.

62. The method of claim 61, wherein said propagation in said non-forward direction comprises propagation of said input signals into selected ones of said neuron clusters comprising said output, wherein said selected ones of said neuron clusters represent a correct output by said neural network with respect to said input signals.

63. The method of claim 61, wherein said inter-cluster neurons have an activation speed that is faster than an activation speed of said neurons.

64. The method of claim 61, wherein said modifying comprises providing an input to said at least some of said connected neuron clusters which resets said value.

65. The method of claim 64, wherein said resetting results in a synchronized activation of said at least some of said connected neuron clusters with respect to said dataflow path.

66. The method of claim 64, wherein, when said resetting with respect to a specified neuron cluster occurs before an activation of said specified neuron cluster, said resetting results in inhibiting said specified neuron cluster.

67. The method of claim 66, wherein said inhibiting excludes said specified neuron cluster from said dataflow path.

68. The method of claim 61, wherein the neural network is hard-wired or trained to implement a specified said dataflow path with respect to specified said input signals.

69. The method of claim 61, wherein the neural network further comprises at least one of: one or more connection-type neurons configured for modulating the effect of said input signals on said neuron clusters, and one or more auxiliary neuron clusters configured for providing a feedback loop which sustains activation of at least some of said neuron clusters.
